(19) United States
(12) Patent Application Publication
(10) Pub. No.: US 2026/0267259 A1
(43) Pub. Date: Sep. 10, 2026

(54) DEVELOPING DEVICE

(71) Applicant: CANON KABUSHIKI KAISHA, Tokyo (JP)

(72) Inventors: Ryota Ooka, Shizuoka (JP); Makoto Hayashida, Shizuoka (JP); Ryuta Murakami, Shizuoka (JP); Joji Goto, Shizuoka (JP); Tetsuo Uesugi, Shizuoka (JP)

(21) Appl. No.: 19/550,612

(22) Filed: Feb. 26, 2026

(30) Foreign Application Priority Data
Mar. 6, 2025 (JP) 2025-035939

(51) Int. Cl. G03G 15/08; G03G 15/00

(52) U.S. Cl. CPC G03G 15/0856; G03G 15/0808; G03G 15/0889; G03G 15/556; G03G 15/80

(57) ABSTRACT

A developing device includes a developing roller, a frame body having an accommodating portion for accommodating developer, and a first conductive portion and a second conductive portion integrally molded. The first conductive portion includes a first electrode portion exposed from the frame body inside the accommodating portion and a first electrical contact portion electrically connected to the first electrode portion and exposed from the frame body outside the accommodating portion. The second conductive portion includes a second electrode portion exposed from the frame body inside the accommodating portion and a second electrical contact portion electrically connected to the second electrode portion and exposed from the frame body outside the accommodating portion. The first electrode portion and the second electrode portion are disposed so as to face each other with a space therebetween and function as a capacitor.

### BACKGROUND

### Field of the Technology

The present disclosure relates to a developing device used in electrophotographic image forming apparatuses.

### Description of the Related Art

Conventionally, an electrostatic capacitance method is widely known as toner remaining amount detection unit for detecting the remaining amount of toner in a toner accommodating portion of a process cartridge and a toner cartridge. The electrostatic capacitance method forms a capacitor by disposing at least two electrodes in the toner accommodating portion, and detects the toner remaining amount by detecting a change in electrostatic capacitance between the capacitor electrodes. Of the two electrodes constituting the capacitor, a first electrode receives supply of an AC voltage, and a second electrode is connected to a current detection circuit, and the toner remaining amount is detected by detecting, with the current detection circuit, a displacement current flowing through the capacitor due to the AC voltage. As a capacitor electrode in the toner accommodating portion, a configuration in which a conductive sheet is fixed to a developer accommodating frame body has been proposed (see, for example, Japanese Patent Application Publication No. 2018-10277 and Japanese Patent Application Publication No. 2023-174061).

### SUMMARY

The present disclosure is directed to provide an improved cartridge or an improved electrophotographic image forming apparatus.

In order to solve the above-described problems, a developing device of the present disclosure includes:
a developing roller;
a frame body having an accommodating portion for accommodating developer to be borne on the developing roller, the frame body is formed of an insulating resin; and
a first conductive portion and a second conductive portion integrally molded by injecting a conductive resin into the frame body,
wherein the first conductive portion includes a first electrode portion and a first electrical contact portion, the first electrode portion being exposed in the accommodating portion, the first electrical contact portion being electrically connected to the first electrode portion and being exposed outside the accommodating portion,
wherein the second conductive portion includes a second electrode portion and a second electrical contact portion, the second electrode portion being exposed from the frame body inside the accommodating portion, the second electrical contact portion being electrically connected to the second electrode portion and being exposed from the frame body outside the accommodating portion,
wherein the first electrode portion and the second electrode portion are disposed so as to face each other with a space therebetween and are configured to function as a capacitor when a voltage is applied between the first electrical contact portion and the second electrical contact portion.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a developing unit according to an embodiment of the present disclosure.

FIG. 2A is a cross-sectional view of a first electrode and a second electrode that form a detection capacitor in an embodiment of the present disclosure.

FIG. 2B is a cross-sectional view showing an electric field formed between the first electrode and the second electrode that form the detection capacitor in an embodiment of the present disclosure.

FIG. 3 is a cross-sectional view of an image forming apparatus main body.

FIG. 4 is a cross-sectional view of a process cartridge.

FIG. 5 is a perspective view of the process cartridge.

FIG. 6A is a perspective view of an electrode holder that holds the first electrode and the second electrode.

FIG. 6B is a perspective view with the electrode holder removed from the state shown in FIG. 6A.

FIG. 7A is a perspective view showing a positional relationship between the process cartridge and a laser scanner.

FIG. 7B is a perspective view from an angle different from FIG. 7A showing the positional relationship between the process cartridge and the laser scanner.

FIG. 8A is a perspective view of a frame member as viewed from below.

FIG. 8B is a view with a cover member removed from FIG. 8A.

FIG. 9A is a perspective view of a second substrate, a substrate holder, a first spring, and a second spring.

FIG. 9B is a perspective view of the second substrate, the substrate holder, the first spring, and the second spring from an angle different from FIG. 9A.

FIG. 9C is a perspective view of the second substrate, the substrate holder, the first spring, and the second spring from an angle different from FIGS. 9A and 9B.

FIG. 10 is an explanatory diagram of a positional relationship among the developing unit, a first electrical contact, and a second electrical contact.

FIG. 11A is a cross-sectional view showing a state in which a detection capacitor mold core is moved relative to the detection capacitor mold cavity in a direction X4 in a forming method (primary molding) by conductive two-color molding of the detection capacitor.

FIG. 11B is a cross-sectional view showing a state in which mold clamping is performed with the detection capacitor mold core pressed against the detection capacitor mold cavity after FIG. 11A.

FIG. 11C is a cross-sectional view showing a state in which an electrode holder is formed (primary molding) by the forming method (primary molding) by conductive two-color molding of the detection capacitor.

FIG. 12A is a cross-sectional view showing a state in which a detection capacitor mold first core back space and a second core back space are formed by moving a detection capacitor mold first core back portion and a detection capacitor mold second core back portion toward a direction X3 in a forming method (secondary molding) by conductive two-color molding of the detection capacitor.

FIG. 12B is a cross-sectional view showing a state in which a detection capacitor composed of the first electrode and the second electrode is formed (secondary molding) in the detection capacitor mold first core back space and the detection capacitor mold second core back space in the forming method (secondary molding) by conductive two-color molding of the detection capacitor.

FIG. 13A is a cross-sectional view showing a state in which the detection capacitor mold core is moved in the direction X3 of the detection capacitor after formation of a detection capacitor C in a forming method (mold release) by conductive two-color molding of the detection capacitor.

FIG. 13B is a cross-sectional view showing a state in which a remaining amount detection member is released from the detection capacitor mold cavity and the detection capacitor mold core and conductive two-color molding is completed in the forming method (mold release) by conductive two-color molding of the detection capacitor.

FIG. 14A is a front view showing a configuration of the remaining amount detection member.

FIG. 14B is an A-A cross-sectional view showing a toner seal structure of FIG. 14A.

FIG. 14C is a B-B cross-sectional view showing the toner seal structure of FIG. 14A.

FIG. 14D is a detailed view of the toner seal structure described in FIGS. 14B and 14C.

FIG. 15 is a cross-sectional view showing a configuration of the electrical contacts and a developing contact.

FIG. 16A is a perspective view showing a flow passage of conductive resin branched into a first electrode gate portion and a second electrode gate portion in conductive resin molding.

FIG. 16B is a perspective view showing a first electrode flow passage and a second electrode flow passage which are flow passages of conductive resin branched toward a longitudinal direction Z1 which is a side toward the electrical contacts and a longitudinal direction Z2 which is a side toward the detection capacitor.

FIG. 17A is a perspective view showing a flow passage of conductive resin on the longitudinal direction Z2 side that flows beyond a first electrode toner sealing portion and a second electrode toner sealing portion to a part of the detection capacitor in conductive resin molding.

FIG. 17B is a perspective view showing that molding of the detection capacitor is completed in conductive resin molding.

FIG. 18 is an explanatory diagram showing electrostatic capacitance simulation results of the present embodiment and comparative examples.

FIG. 19A is a cross-sectional view showing a comparative example 1 of the detection capacitor with respect to the present embodiment.

FIG. 19B is a cross-sectional view showing a comparative example 2 of the detection capacitor with respect to the present embodiment.

FIG. 20 is a block diagram of a wiring configuration among a high-voltage circuit, a detection circuit, and the process cartridge.

FIG. 21 is an equivalent circuit diagram showing the configuration of FIG. 20 with circuit constants.

FIG. 22A is a time-series explanatory diagram showing a pulsating waveform of a toner remaining amount detection signal that periodically changes by an amplitude ΔV at time intervals of a stirring cycle.

FIG. 22B is a time-series explanatory diagram showing a waveform of the toner remaining amount detection signal when a stray capacitance in the remaining amount detection circuit becomes excessively high.

FIG. 22C is a time-series explanatory diagram showing a waveform of the toner remaining amount detection signal when parasitic resistance in the remaining amount detection circuit is excessively high or the electrostatic capacitance of the detection capacitor is excessively low.

### DESCRIPTION OF THE EMBODIMENTS

Exemplary embodiments of the present disclosure will now be described in detail with reference to the accompanying drawings. In this regard, the dimensions, materials, shapes, relative arrangements thereof, and the like of the components described in the embodiments may be appropriately modified according to the configurations and various conditions of apparatuses to which the present disclosure is applied. That is, the scope of the present disclosure is not intended to be limited to the embodiments described below. While a plurality of features are described in each of the embodiments, all of the plurality of features are not necessarily essential to the present disclosure and the plurality of features may be combined with each other in any way. Moreover, in the accompanying drawings, the same reference numerals are assigned to the same or similar components, and redundant descriptions thereof are omitted.

Here, a developing unit (developing device) refers to something that has at least one of toner, a toner accommodating portion, a developer bearing member, and a process unit acting on the developer bearing member, and is detachably mountable to an electrophotographic image forming apparatus main body (hereinafter referred to as “apparatus main body”). Representative examples of the developing unit include a developing cartridge, a process cartridge, and a toner cartridge. A developing cartridge is something in which a developer bearing member and a process unit acting on the developer bearing member are formed into a cartridge and mounted detachably to the apparatus main body. A process cartridge is something in which an image bearing member and a process unit acting on the image bearing member are formed into a cartridge and mounted detachably to the apparatus main body. A toner cartridge is something that accommodates developer (hereinafter referred to as “toner”) to be supplied to developing member such as a developer bearing member and is mounted detachably to the apparatus main body. Further, an electrophotographic image forming apparatus is something that forms an image on a recording medium using an electrophotographic image forming method. Examples of the electrophotographic image forming apparatus include, for example, an electrophotographic copying machine, an electrophotographic printer (LED printer, laser beam printer, etc.), a facsimile apparatus, and a word processor.

### Embodiment 1

### Overall Overview of Image Forming Apparatus Main Body

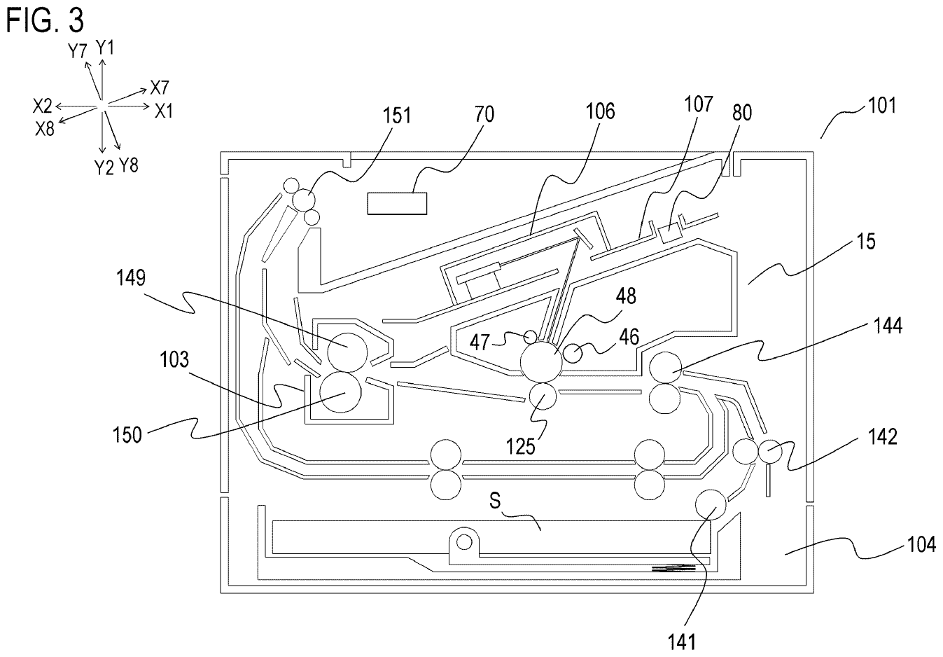

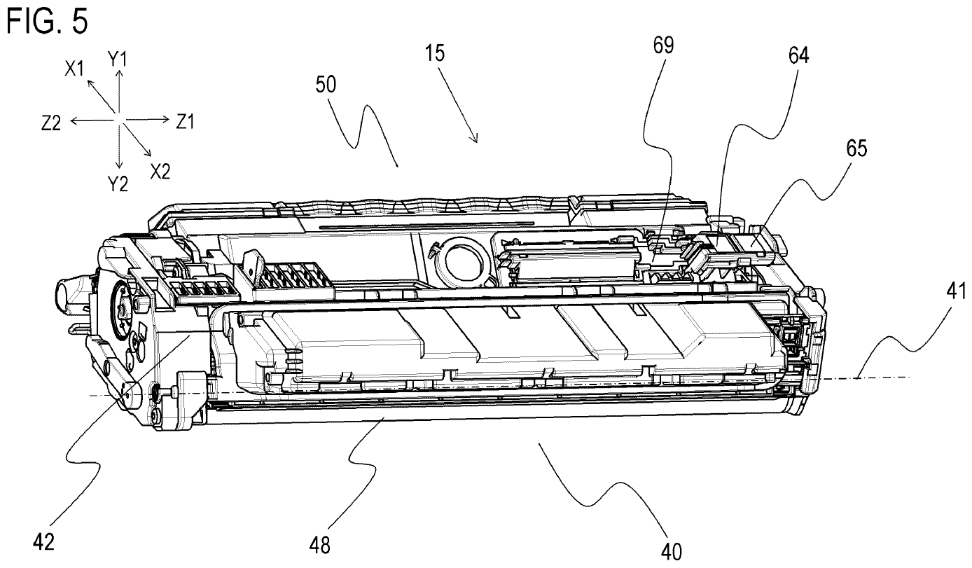

FIG. 3 is a cross-sectional view showing a schematic configuration of a monochrome laser printer which is an example of an image forming apparatus. The image forming apparatus main body (hereinafter referred to as apparatus main body 101) shown in FIG. 3 roughly includes a sheet feeding portion, an image forming portion that forms an image on a sheet, a fixing portion, a sheet discharge reversing portion, and a duplex conveying portion. Here, let a horizontal direction be X1 and X2 and a vertical direction be Y1 and Y2 in an image forming posture of the apparatus main body 101. Further, as shown in FIG. 5, let a direction perpendicular to the horizontal direction X1 and X2 and the vertical direction Y1 and Y2 be a longitudinal direction Z1 and Z2. The apparatus main body 101 includes a process cartridge 15 that is detachably mountable to the apparatus main body 101. The process cartridge 15 is a process unit for forming a toner image on a sheet S using an electrophotographic process, and has a process unit such as a photosensitive drum 48 as an image bearing member, a charging roller 47, and a developing roller 46 as a developer bearing member. Here, let a mounting direction of the process cartridge 15 to the apparatus main body 101 be X7 and X8, and a mounting vertical direction be Y7 and Y8.

A laser scanner 106 is disposed above the process cartridge 15, and performs exposure on the photosensitive drum 48 based on an image signal. The photosensitive drum 48 is charged to a predetermined negative polarity potential by the charging roller 47. Thereafter, the laser scanner 106 scans the photosensitive drum 48 with a laser beam, whereby an electrostatic latent image is formed on the photosensitive drum 48. Thereafter, toner is supplied and developed from the developing roller 46 onto the photosensitive drum 48 and visualized as a toner image.

The sheet feeding portion has a sheet feeding roller 141 mounted to the apparatus main body 101 and a sheet feeding cassette 104 detachably mountable to the apparatus main body 101. Sheets S accommodated in the sheet feeding cassette 104 are separated and fed one by one by the sheet feeding roller 141. The fed sheet Sis conveyed to a registration roller pair 144 by a conveying roller pair 142, skew correction is performed by the registration roller pair 144, and the sheet is conveyed to a transfer portion.

In the transfer portion, a configuration is provided in which a positive polarity bias is applied to a transfer roller 125 by a bias applying unit (not shown). As a result, the toner image on the photosensitive drum 48 is transferred onto the sheet S conveyed to the transfer portion.

The sheet S onto which the toner image has been transferred is conveyed to a fixing device 103 provided on a downstream side in a conveying direction as viewed from the transfer portion. The fixing device 103 fixes the toner image transferred onto the sheet S to the sheet S, and has a heating unit 149 including a heater which is heating member (not shown) and a pressure roller 150 which is a pressure member that rotates in pressure contact with the heating unit. The sheet S on which the toner image is formed is nipped and conveyed in a nip portion formed by the heating unit 149 and the pressure roller 150, and the toner image is fixed to a surface of the sheet S by applying heat and pressure.

The sheet S on which the toner image has been fixed is discharged to the outside of the machine by a sheet discharge roller pair 151.

### Overall Process Cartridge

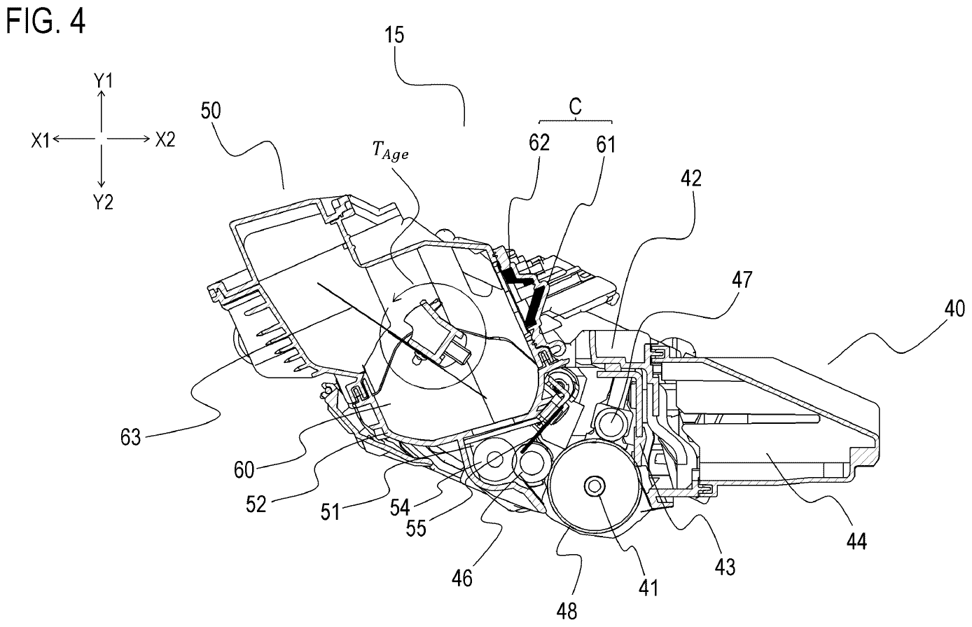

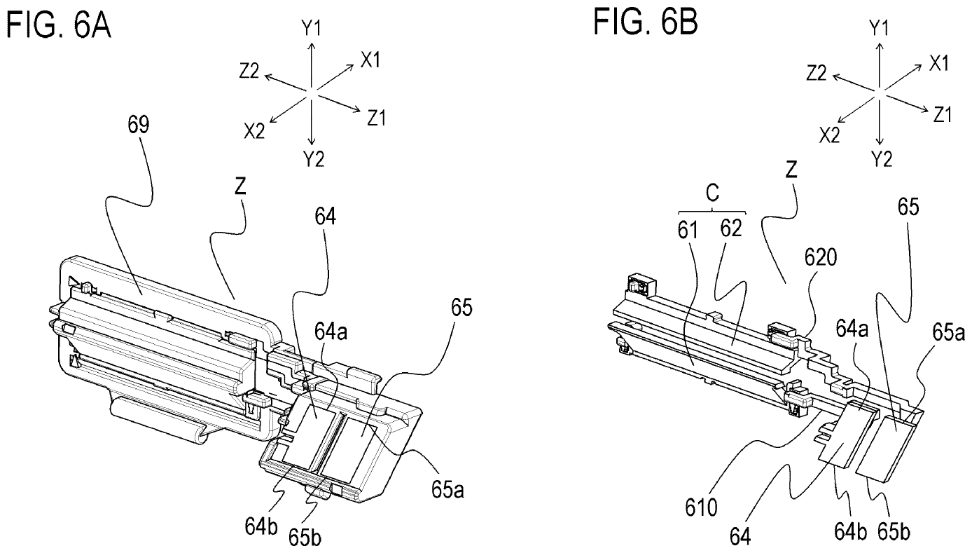

An overall configuration of the process cartridge 15 will be described with reference to FIGS. 4 to 6A and 6B. FIG. 4 is a cross-sectional view of the process cartridge 15, and FIG. 5 is a perspective view of the process cartridge 15. FIG. 6A is a perspective view of an electrode holder 69 that holds a first electrode 61 and a second electrode 62. FIG. 6B is a perspective view with the electrode holder 69 removed from the state shown in FIG. 6A.

The process cartridge 15 is composed of a cleaning unit 40 provided with the photosensitive drum 48 and a developing unit 50 provided with the developing roller 46, and is detachably mountable to the apparatus main body 101.

The cleaning unit 40 has the photosensitive drum 48, a drum support member 42 that rotatably supports the photosensitive drum 48 around a rotation shaft 41, a cleaning blade 43, and a waste toner accommodating portion 44. The photosensitive drum 48 is rotatably supported around the rotation shaft 41 by the drum support member 42. The charging roller 47 is disposed so as to contact an outer peripheral surface of the photosensitive drum 48, and charges the photosensitive drum 48 by voltage application from the apparatus main body 101. Further, the charging roller 47 is driven to rotate with respect to the photosensitive drum 48. A tip of the cleaning blade 43 elastically contacts the photosensitive drum 48 to remove transfer residual toner (hereinafter referred to as waste toner) remaining on the photosensitive drum 48 after the sheet S passes between the photosensitive drum 48 and the transfer roller 125. The removed waste toner is accommodated in the waste toner accommodating portion 44.

The developing unit 50 has a developing chamber 51 in which the developing roller 46, a supply roller 54, and a developing blade 55 are disposed, and a toner accommodating portion 60 that supplies toner to the developing chamber 51. The developing roller 46 supplies toner to a developing region of the photosensitive drum 48. Then, the developing roller 46 develops the electrostatic latent image formed on the photosensitive drum 48 using toner (developer). The developing blade 55 abuts against the developing roller 46 to regulate an amount of toner adhering to a peripheral surface of the developing roller 46 and at the same time imparts frictional charging charge to the toner. The supply roller 54 rubs against the developing roller 46 to supply toner in the developing chamber 51 to the developing roller 46 while scraping off excess toner adhering to the developing roller 46. The developing blade 55 abuts against the peripheral surface of the developing roller 46 to regulate the amount of toner adhering to the peripheral surface of the developing roller 46. Further, the developing blade imparts frictional charging charge to the toner.

Toner accommodated in the toner accommodating portion 60 is sent to the developing chamber 51 by rotation of a stirring member 63 and supplied to the developing roller 46. Further, a detection capacitor C that forms electrostatic capacitance is provided in the toner accommodating portion 60. In a frame body of the developing unit 50 that constitutes the toner accommodating portion 60, a first electrode 61 as a first electrode portion and a second electrode 62 as a second electrode portion, which are used for detecting electrostatic capacitance inside the toner accommodating portion 60, are provided so as to be exposed to the toner accommodating portion 60, respectively. In a rotation direction of the stirring member 63, the first electrode 61 is located on an upstream side and the second electrode 62 is located on a downstream side. The detection capacitor C is formed of the first electrode 61 and the second electrode 62 and is disposed substantially parallel to the longitudinal direction Z1 and Z2. That is, the first electrode 61 and the second electrode 62 are disposed so as to face each other with a space therebetween inside the toner accommodating portion 60, and are configured to function as a capacitor when a voltage is applied between a first electrical contact 64 and a second electrical contact 65, which will be described later. Toner enters and exits between the first electrode 61 and the second electrode 62 by rotation of the stirring member 63. Due to toner entering and exiting inside the detection capacitor C, the electrostatic capacitance between the first electrode 61 and the second electrode 62 changes according to a rotation cycle T_{Age} of the stirring member 63 (hereinafter referred to as stirring cycle T_{Age}).

As shown in FIG. 6A, a first electrical contact 64 as a first electrical contact portion and a second electrical contact 65 as a second electrical contact portion for contacting springs (not shown) on the apparatus main body side, which will be described later, are exposed from the electrode holder 69. As shown in FIG. 6B, the first electrode 61 inside the developing unit 50 and the first electrical contact 64 are configured to be electrically connected by being integrally molded with conductive resin (electroconductive resin). Similarly, the second electrode 62 inside the developing unit 50 and the second electrical contact 65 are configured to be electrically connected by being integrally molded with conductive resin. More specifically, the frame body of the developing unit 50 is composed of an insulating portion having insulating properties and an conductive portion having conductive properties. The latter conductive portion is integrally molded with the former insulating portion so as to be exposed to each of an inside (toner accommodating portion 60) and an outside of the frame body. The conductive portion includes a first conductive portion (first connection portion) in which a part exposed to the toner accommodating portion 60 becomes the first electrode 61 and a part exposed to an outside of the frame body becomes the first electrical contact 64, and a second conductive portion (second connection portion) in which a part exposed to the toner accommodating portion 60 becomes the second electrode 62 and a part exposed to the outside of the frame body becomes the second electrical contact 65. Further, the insulating portion is divided into a part (first insulating portion, first frame body portion) that pivotally supports the stirring member 63 and the like, and a part (second insulating portion, second frame body portion) that is configured separately from the part and to which the conductive portion is integrally molded, the former being a developing frame body 52 and the latter part being the electrode holder 69.

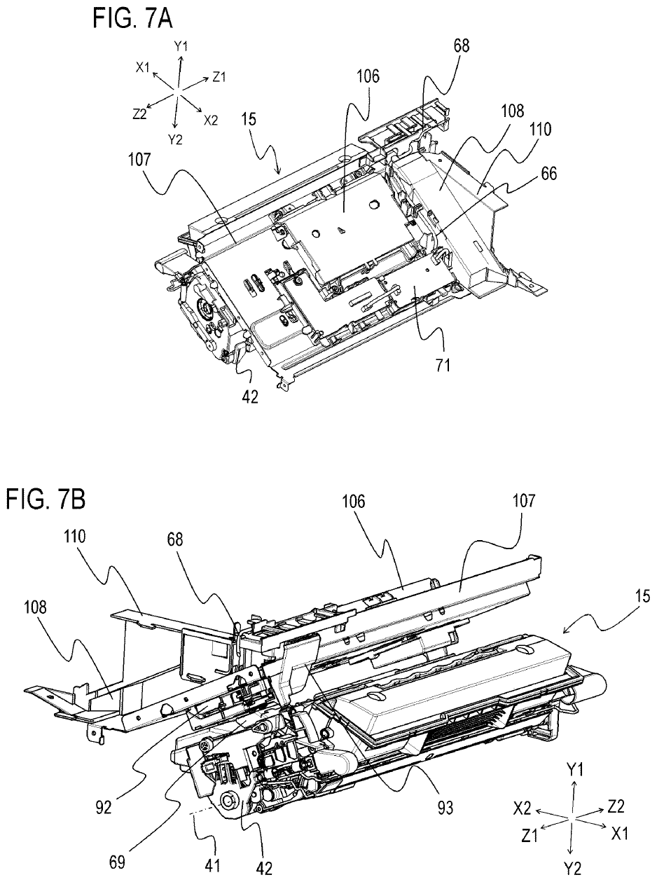

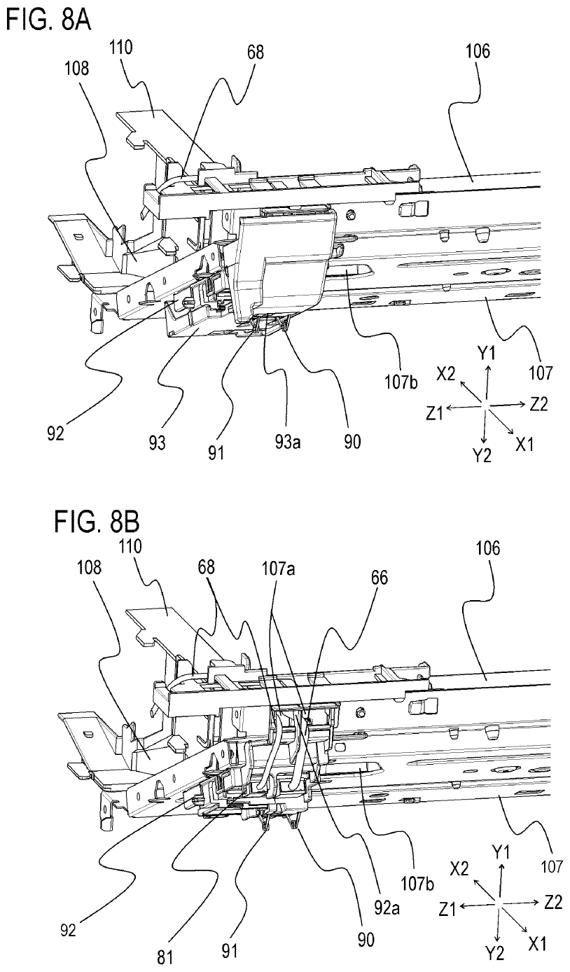

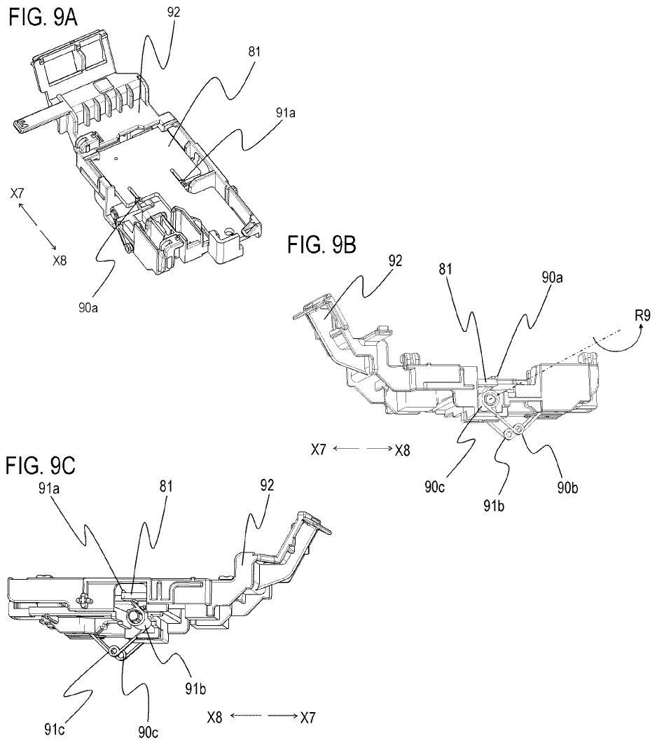

Next, a configuration of the apparatus main body 101 in the present embodiment will be described in detail with reference to FIGS. 7A and 7B to 9A to 9C. FIGS. 7A and 7B are perspective views showing a positional relationship between the process cartridge 15 and the laser scanner 106. FIG. 8A is a perspective view of a frame member 107 as viewed from below, and FIG. 8B is a view with a cover member 93 removed from FIG. 8A. FIGS. 9A to 9C are perspective views of a second substrate 81, a substrate holder 92, a first spring 90, and a second spring 91.

As shown in FIGS. 7A and 7B, the laser scanner 106 disposed above the process cartridge 15 in a gravitational direction is fixed to a metal frame member 107 disposed between the laser scanner 106 and the process cartridge 15. By fixing to the metal frame member 107, the process cartridge 15 and the laser scanner 106 can be disposed with high rigidity and high precision. A first substrate 71 including an AC voltage output circuit is fixed above the frame member 107. Further, a second substrate 81 (see FIG. 8B) including a current detection circuit is disposed below the frame member 107, and the second substrate 81 is held by a substrate holder 92. The first substrate 71 and the second substrate 81 are electrically connected by a cable (AC voltage line) 66. The second substrate 81 will be described later. A duct 108 for cooling the photosensitive drum 48 is provided on the frame member 107. The cable (AC voltage line) 66 is routed along the duct 108, and as shown in FIG. 8B, passes through a hole 107a provided in the frame member 107 and is connected to the second substrate 81. The second substrate 81 and an engine controller (not shown) are connected by a cable (signal line) 68, and the cable (signal line) 68 is routed through the hole 107a of the frame member similarly to the cable (AC voltage line) 66.

As shown in FIGS. 8B and 9A to 9C, the substrate holder 92 also holds a first spring 90 and a second spring 91 (hereinafter referred to as electrical contact springs). The electrical contact springs 90 and 91 are torsion springs, and fixed end sides 90a and 91a contact the second substrate 81. Free end sides 90b and 91b of the electrical contact springs 90 and 91 contact the first electrical contact 64 and the second electrical contact 65 provided in the developing unit 50 with a predetermined pressure. Coil portions 90c and 91c of the torsion springs are disposed on an upstream side with respect to abutting portions 90b and 91b on the free end side with the first electrical contact 64 and the second electrical contact 65, with respect to an insertion direction of the process cartridge 15, and are configured to rotate in a torsion spring rotation direction R9 shown in FIG. 9B in accordance with insertion of the process cartridge 15. As shown in FIG. 8A, the substrate holder 92, the first spring 90, and the second spring 91 are covered by a cover member 93, and the abutting portions 90b and 91b on the free end side of the first spring 90 and the second spring 91 are configured to be exposed through a hole 93a provided in the cover member 93. The abutting portions 90b and 91b have a shape wound in a one-turn coil shape.

### Toner Remaining Amount Detection Circuit

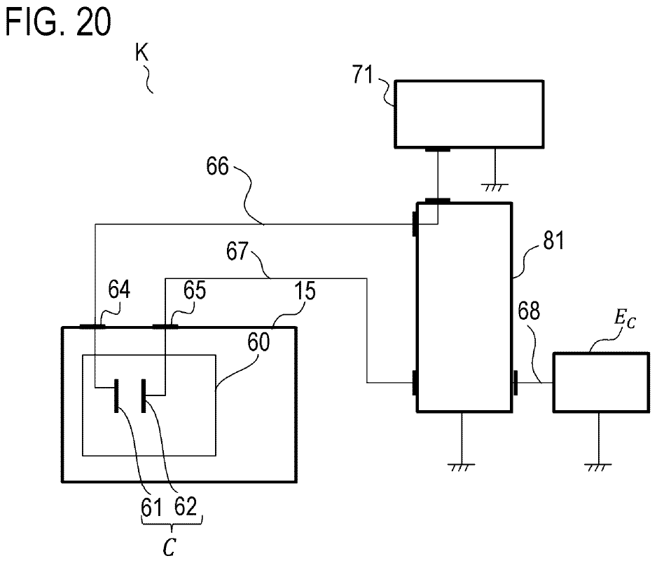

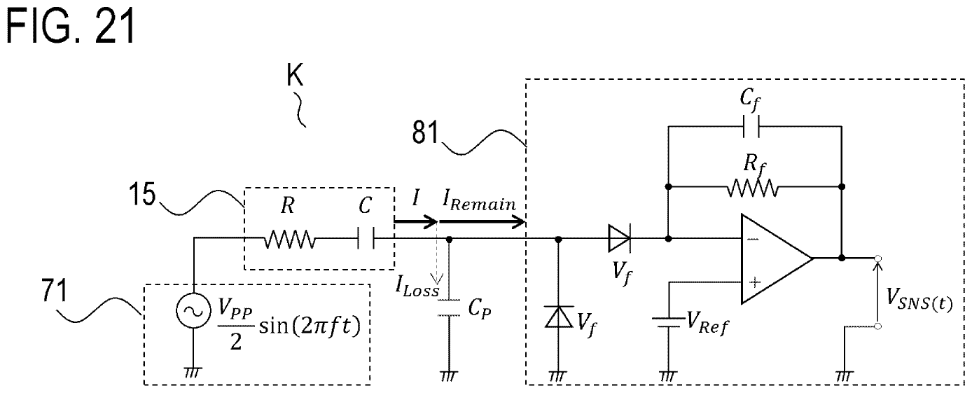

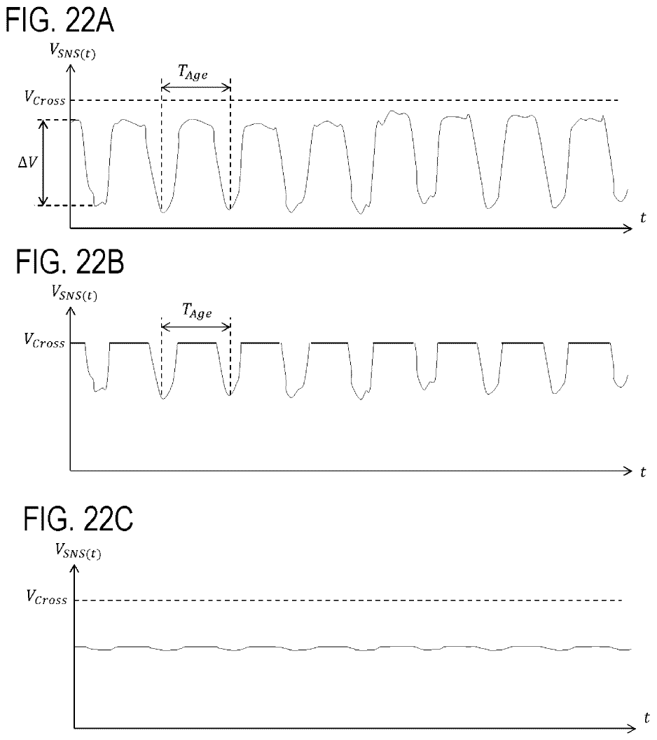

A configuration of a toner remaining amount detection circuit K (hereinafter referred to as remaining amount detection circuit K) in an embodiment of the present disclosure and a toner remaining amount detection signal V_{(SNS(t))} (hereinafter referred to as remaining amount detection signal V_{(SNS(t))}) obtained from the remaining amount detection circuit K will be described with reference to FIGS. 9A to 9C, 20, 21, and 22A to 22C. FIG. 20 is a block diagram showing a wiring configuration among the first substrate 71, the second substrate 81, and the process cartridge 15 in the remaining amount detection circuit K. FIG. 21 is an equivalent circuit diagram in which each element of the remaining amount detection circuit K is expressed by electrical circuit constants. FIGS. 22A to 22C are time-series diagrams showing the remaining amount detection signal V_{(SNS(t))} obtained from the remaining amount detection circuit K.

As shown in FIG. 20, the remaining amount detection circuit K is composed of the first substrate 71 (AC voltage output circuit), the process cartridge 15, and the second substrate 81 (current detection circuit). The first substrate 71 is electrically connected to the first electrode 61, which is one end side of the detection capacitor C provided in the process cartridge 15, via the cable (AC voltage line) 66 and the first electrical contact 64. The second electrode 62, which is the other end side of the detection capacitor C, is electrically connected to the second substrate 81 via the second electrical contact 65 and a remaining amount detection signal line 67. The second substrate 81 is electrically connected to an engine controller E_{C} via a cable (signal line) 68.

As shown in FIG. 21, the first substrate 71 is an AC voltage output circuit having an AC power supply, and applies an AC voltage of (V_{PP}/2) sin (2πft) to the process cartridge 15. Here, V_{PP} is an amplitude of the AC voltage, f is a frequency of the AC voltage, π is the mathematical constant pi, and t is elapsed time. The second substrate 81 is composed of a half-wave rectification portion consisting of two half-wave rectification diodes V_{f} and a first-order low-pass filter. The first-order low-pass filter is composed of an operational amplifier driven by a reference voltage V_{Ref}, a detection sensitivity resistor R_{f} for current-voltage conversion, and a cutoff capacitor C_{f} for noise suppression.

The AC voltage input to the process cartridge 15 is output as a displacement current I to the second substrate 81 side via parasitic resistance R existing between the electrical contact springs 90 and 91 shown in FIGS. 9A to 9C and the electrical contacts 64 and 65 shown in FIG. 20, and the detection capacitor C. Since the displacement current I is affected by a stray capacitance C_{P} generated between the frame GND and wiring of other circuits, a part of the displacement current I flows out to the outside of the remaining amount detection circuit K as a displacement current loss I_{Loss}. As a result, an effective displacement current I_{Remain}, which is a residual between the displacement current I and the displacement current loss I_{Loss}, is input to the second substrate 81. The effective displacement current I_{Remain} input to the second substrate 81 is half-wave rectified via the half-wave rectification portion, and then output as the remaining amount detection signal V_{(SNS(t))} by a current-voltage conversion action by the first-order low-pass filter. By applying Ohm's law and Kirchhoff's law to the equivalent circuit shown in FIG. 21 and solving for the remaining amount detection signal V_{(SNS(t))}, the following equation is obtained.

$${V}_{SNS ( t )} = {V}_{ref} - {R}_{f} \{ \frac{\frac{1}{2} ( \frac{{V}_{PP}}{π} - {V}_{f} )}{R + \frac{1}{2 π fC}} - π {fV}_{f} {C}_{P} \}$$

As described above, the electrostatic capacitance of the detection capacitor C periodically changes at time intervals of the stirring cycle T_{Age} due to toner entering and exiting with respect to the detection capacitor C. Therefore, as shown in FIG. 22A, the remaining amount detection signal V_{(SNS(t))} becomes a pulsating waveform that periodically changes by an amplitude ΔV at time intervals of the stirring cycle T_{Age}. This remaining amount detection signal V_{(SNS(t))} is digitally signal-processed by the engine controller E_{C} to calculate the amplitude ΔV and Duty. A correlation between the amplitude ΔV and Duty and the toner remaining amount in the process cartridge 15 is acquired in advance according to a form of the process cartridge 15, and the toner remaining amount is estimated by comparing with the amplitude ΔV and Duty calculated at the time of product use.

From the above equation, when the stray capacitance C_{P} in the remaining amount detection circuit K becomes excessively high, as shown in FIG. 22B, the remaining amount detection signal V_{(SNS(t))} exceeds an allowable detection voltage V_{Cross} and the remaining amount detection signal V_{(SNS(t))} is clipped, so that accurate toner remaining amount detection cannot be performed. Therefore, the stray capacitance C_{P} is reduced by providing a sufficient gap between the wiring from the detection capacitor C to the second substrate 81, that is, the conduction path from the second electrode 62 to the second electrical contact 65 and the remaining amount detection signal line 67, and the frame GND and wiring of other circuits. Further, from the above equation, when the parasitic resistance R in the remaining amount detection circuit K is excessively high or the electrostatic capacitance of the detection capacitor C is excessively low, as shown in FIG. 22C, the amplitude ΔV of the remaining amount detection signal V_{(SNS(t))} cannot be sufficiently obtained, so that accurate toner remaining amount detection cannot be performed. Therefore, the electrostatic capacitance of the detection capacitor C is sufficiently secured while suppressing parasitic resistance R generated between a conduction path from the first electrical contact 64 to the first electrode 61 and a conduction path from the second electrode 62 to the second electrical contact 65.

### Arrangement Configuration of Electrical Contacts

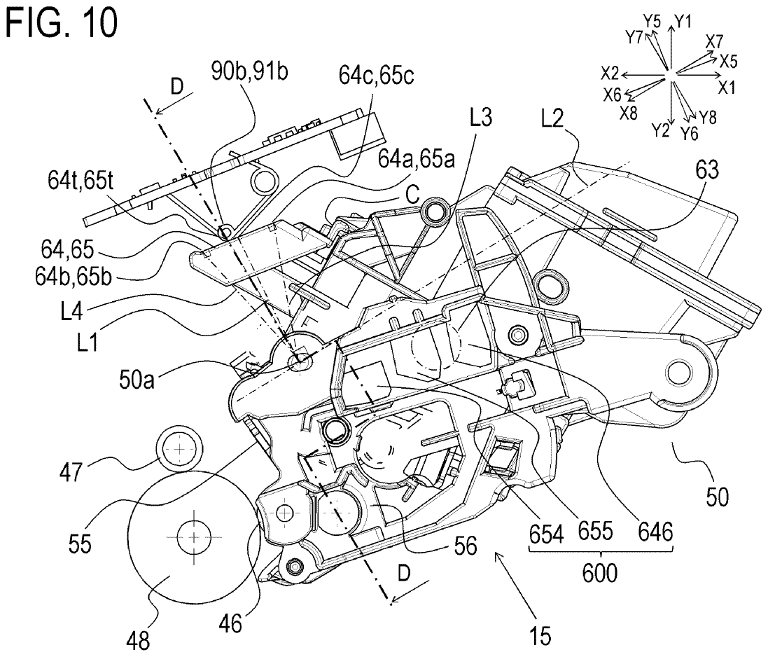

An arrangement configuration of the electrical contacts 64 and 65 will be described with reference to FIGS. 6A, 6B, and 10. FIG. 10 is a side view showing a positional relationship among the developing unit 50 and the electrical contacts 64 and 65. As shown in FIG. 10, the developing unit 50 is provided with a developing contact 600 for supplying a predetermined bias to the developing roller 46, the supply roller 54, and the developing blade 55, respectively. The developing contact 600 is composed of a developing roller contact 646 that supplies bias to the developing roller 46, a supply roller contact 654 that supplies bias to the supply roller 54, and a developing blade contact 655 that supplies bias to the developing blade 55. The developing unit 50 is pivotally supported so as to be swingable around a swing center 50a of the developing unit provided in the process cartridge 15. As a result, the developing unit 50 can take a contact state in which the developing roller 46 contacts the photosensitive drum 48 and a separated state in which the developing roller 46 is separated from the photosensitive drum 48 in a state in which the process cartridge is mounted to the apparatus main body 101 shown in FIG. 3. Switching between the contact state and the separated state is performed by the developing unit 50 rotating around the swing center 50a by receiving pressing from a developing separation mechanism (not shown) provided in the apparatus main body 101. On the other hand, the rotation shaft centers of the photosensitive drum 48 and the charging roller 47 are fixed in a state mounted to the apparatus main body 101. During the image forming operation, toner development onto the photosensitive drum 48 is performed in the contact state, and after the image forming operation is completed, by switching to the separated state when not in use, the contact pressure of the developing roller 46 against the photosensitive drum 48 can be released, so that the service life of the developing roller 46 can be extended.

The electrical contacts 64 and 65 abut against free end sides 90b and 91b of the electrical contact springs 90 and 91 at a first electrical contact abutting portion 64t and a second electrical contact abutting portion 65t (hereinafter referred to as electrical contact abutting portions). The electrical contacts 64 and 65 are formed as surfaces connecting a first electrical contact first end portion 64a and a second electrical contact first end portion 65a (hereinafter referred to as electrical contact first end portions) and a first electrical contact second end portion 64b and a second electrical contact second end portion 65b (hereinafter referred to as electrical contact second end portions). Here, midpoints of the electrical contact first end portions 64a and 65a and the electrical contact second end portions 64b and 65b are defined as a first electrical contact center portion 64c and a second electrical contact center portion 65c (hereinafter referred to as electrical contact center portions), respectively. In addition, a line connecting the electrical contact center portions 64c and 65c and the swing center 50a is defined as a first line L1, and a line perpendicular to the first line L1 and passing through the swing center 50a is defined as a second line L2, respectively.

Next, an axial direction passing through the electrical contact first end portions 64a and 65a and the electrical contact second end portions 64b and 65b is defined as an electrical contact parallel direction X5 and X6, and an axial direction perpendicular to the electrical contact parallel direction X5 and X6 is defined as an electrical contact perpendicular direction Y5 and Y6. Further, a line passing through the electrical contact first end portions 64a and 65a and the swing center 50a is defined as a third line L3, and a line passing through the electrical contact second end portions 64b and 65b and the swing center 50a is defined as a fourth line L4, respectively.

An angle formed between the electrical contact parallel direction X5 and X6 and the mounting direction X7 and X8 of the process cartridge 15 in the present embodiment is provided at 15° or less. From the viewpoint of downsizing the apparatus main body 101 and suppressing contact abrasion due to fluctuation of electrical contact pressure when mounting the process cartridge 15, the above angle is reduced as much as possible. Further, the arrangement of the electrical contact abutting portions 64t and 65t is arranged so as to approach the electrical contact center portions 64c and 65c. This is from the viewpoint of securing an engagement amount between the electrical contacts 64 and 65 and the free end sides 90b and 91b of the electrical contact springs 90 and 91 when component tolerances and creep deformation due to long-term storage are taken into account.

The first line L1 in the present embodiment is provided so that

$$L 1 \leq L 3 and L 1 \leq L 4$$

with respect to the third line L3 and the fourth line L4. Therefore, compared to a case where the inclination of the contact surfaces of the electrical contacts 64 and 65 is

$$L 3 < L 1 < L 4 or L 3 > L 1 > L 4 ,$$

abrasion of the electrical contacts 64 and 65 due to fluctuation of contact pressure when switching between the contact state and the separated state of the developing unit 50 is suppressed, and the service life of the product can be extended. In addition, since an increase in contact resistance due to abrasion of the electrical contacts 64 and 65 can be suppressed, an increase in parasitic resistance, which is an attenuation factor of the remaining amount detection signal V_{(SNS(t))}, can be prevented. As a result, it becomes possible to secure toner remaining amount detection accuracy by stabilizing the remaining amount detection signal V_{(SNS(t))} throughout the product life.

In the present embodiment, the contact surfaces of the electrical contacts 64 and 65 are formed in a planar shape with

$$L 1 < L 3 and L 1 < L 4 ,$$

but it is also possible to form them in a circular arc shape centered on the swing center 50a with

$$L 1 = L 3 and L 1 = L 4 .$$

The shape of the contact surfaces of the electrical contacts 64 and 65 is formed in a planar shape from the viewpoint of cost reduction and inspection by simplifying the shape.

### Arrangement Configuration of Electrical Contacts and Developing Contact

The developing roller 46 and the supply roller 54 are rotatably supported by a developing bearing 56 provided in the developing unit 50. Inside the developing bearing 56, the developing contact 600 and respective power supply passages from the developing contact 600 to the developing roller 46, the supply roller 54, and the developing blade 55 are respectively provided by two-color molding of conductive resin. The developing contact 600, that is, the developing roller contact 646, the supply roller contact 654, and the developing blade contact 655, are electrically connected to the developing roller 46, the supply roller 54, and the developing blade 55 via the respective power supply passages. The developing contact 600 may be formed by two-color molding of conductive resin integrally with each power supply passage, or may be provided separately from each power supply passage using a metal sheet.

The electrical contacts 64 and 65 of the present embodiment are disposed opposite to the developing contact 600, the developing roller 46, the supply roller 54, and the developing blade 55 with the second line L2 as a boundary. Further, in the image forming posture of the process cartridge 15, the electrical contacts 64 and 65 are disposed above the developing contact 600 in the vertical direction Y1. In addition, normal directions of the electrical contacts 64 and 65 are provided facing the electrical contact perpendicular direction Y5, and a vertical direction component of the electrical contact perpendicular direction Y5 coincides with the vertical direction Y1.

In the present embodiment, as shown in FIGS. 10 and 20, the remaining amount detection circuit K composed of the electrical contacts 64 and 65 and the detection capacitor C is disposed in a first phase, and a developing circuit composed of the developing contact 600, the developing roller 46, the supply roller 54, and the developing blade 55 is disposed in a second phase, separately from each other. Therefore, clipping of the remaining amount detection signal V_{(SNS(t))} due to the stray capacitance C_{P} between the remaining amount detection circuit and the developing circuit can be prevented, so that toner remaining amount detection using the electrostatic capacitance method can be performed with high accuracy. From the viewpoint of suppressing the stray capacitance C_{P}, the electrical contacts 64 and 65 are disposed as far away as possible from the developing contact 600, and an inter-wiring distance in the power supply passages of the entire remaining amount detection circuit K and the developing circuit is secured to be at least 5 mm. Further, the normal of the developing contact 600 in the present embodiment is disposed in the longitudinal direction Z1, that is, on a longitudinal direction outer side with respect to the process cartridge 15. In contrast, the electrical contacts 64 and 65 are provided above the developing contact 600 in the vertical direction Y1, and the vertical direction component of the electrical contact perpendicular direction Y5, which is the normal direction of the electrical contacts 64 and 65, coincides with the vertical direction Y1. Therefore, in an arrangement space on a horizontal direction X1-vertical direction Y1 coordinate system which is an arbitrary cross section of the process cartridge 15, the electrical contacts 64 and 65 and the developing contact 600 are separately disposed with different normal directions. As a result, the electrical contacts 64 and 65 and the developing contact 600 can each secure sufficient arrangement space taking into account component tolerances. As a result, at the time of mounting to the apparatus main body 101, the electrical contacts 64 and 65 and the developing contact 600 can perform stable electrical connection without interfering with each other. In addition, the normals of the electrical contacts 64 and 65 and the developing contact 600 are each disposed in a direction different from the vertical direction Y2 side which is downward in the gravitational direction. For example, there are cases where the process cartridge 15 is taken out from the apparatus main body 101 for reasons such as jam processing during use of the apparatus main body 101 and placed in another place such as a desk or workbench. Even in such a case, it is possible to suppress a risk of damage such as dents and scratches to the electrical contacts 64 and 65 and the developing contact 600.

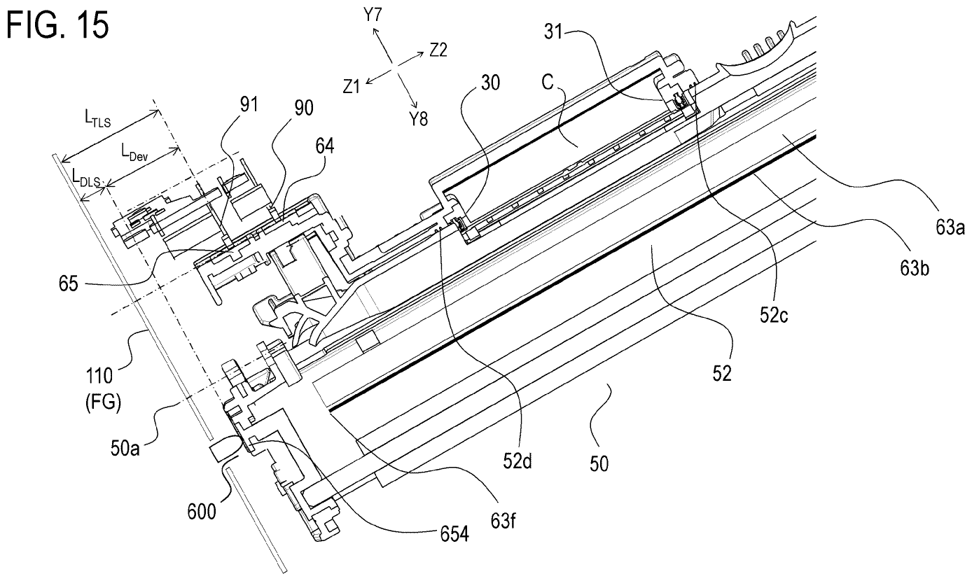

Next, an arrangement configuration of the electrical contacts 64 and 65 and the developing contact 600 in the longitudinal direction Z1 and Z2 will be described with reference to FIG. 15. FIG. 15 is a D-D cross-sectional view of the electrical contacts 64 and 65 and the developing contact 600 in FIG. 10. As shown in FIG. 15, a supply roller contact 654, which is a part of the developing contact 600, is provided at an end portion on the longitudinal direction Z1 side of the developing unit 50. The other developing contacts, the developing roller contact 646 and the developing blade contact 655, also have a common longitudinal arrangement with the supply roller contact 654. The second electrical contact 65 and the second spring 91 are disposed opposite to the developing contact 600 with an interval of an electrical contact-developing contact longitudinal distance L_{Dev} in the longitudinal direction Z1 and Z2. In addition, the second electrical contact 65 and the second spring 91 are disposed opposite to a left side plate 110 which is a frame ground FG with an interval of an electrical contact-left side plate longitudinal distance L_{TLS}. The developing contact 600 is disposed opposite to the left side plate 110 with an interval of a developing contact-left side plate longitudinal distance L_{DLS} which is a difference between the electrical contact-left side plate longitudinal distance L_{TLS} and the electrical contact-developing contact longitudinal distance L_{Dev}.

The electrical contact-left side plate longitudinal distance L_{TLS} and the electrical contact-developing contact longitudinal distance L_{Dev} are provided longer than the developing contact-left side plate longitudinal distance L_{DLS}. Therefore, also from the viewpoint of the longitudinal direction Z1 and Z2, clipping of the remaining amount detection signal V_{(SNS(t))} due to the stray capacitance C_{P} between the remaining amount detection circuit K and the developing circuit and between the remaining amount detection circuit K and the left side plate 110 can be prevented. Therefore, it becomes possible to perform toner remaining amount detection using the electrostatic capacitance method with high accuracy.

### Manufacturing Method of Remaining Amount Detection Member Z

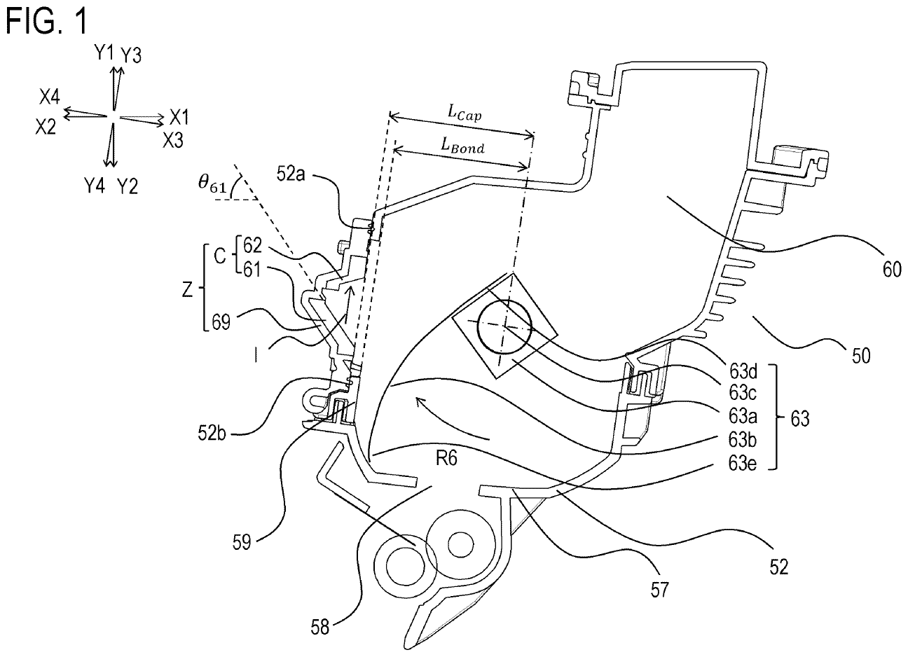

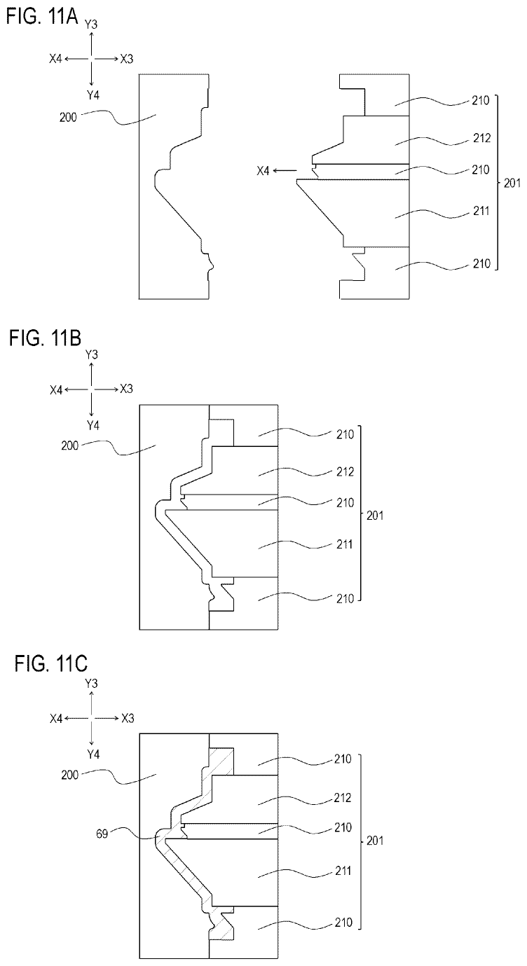

A manufacturing method of a remaining amount detection member Z composed of the detection capacitor C and the electrode holder 69 will be described with reference to FIGS. 1A to 1C and 11A to 11C to 13A and 13B. FIG. 1 is a cross-sectional view showing a configuration of the developing unit 50 and the detection capacitor C. FIGS. 11A to 11C to 13A and 13B are cross-sectional views showing a forming method of the remaining amount detection member Z by conductive two-color molding.

As shown in FIGS. 11A to 11C to 13A and 13B, the detection capacitor C is injection-molded by a detection capacitor mold cavity 200 which is a fixed-side mold and a detection capacitor mold core 201 which is a movable-side mold. The detection capacitor mold core 201 is composed of a detection capacitor mold core base portion 210, a detection capacitor mold first core back portion 211, and a detection capacitor mold second core back portion 212. The detection capacitor mold first core back portion 211 and the detection capacitor mold second core back portion 212 are configured to be translatable toward a detection capacitor closest perpendicular direction X3 and X4 which is a mold clamping direction with respect to the detection capacitor mold core base portion 210.

First, as shown in FIG. 11A, the detection capacitor mold core 201 is moved relative to the detection capacitor closest perpendicular direction X4 with respect to the detection capacitor mold cavity 200, and as shown in FIG. 11B, is pressed against the detection capacitor mold cavity 200. In this state, mold clamping is performed and an insulating resin which is a first molding material is molded in the mold, whereby as shown in FIG. 11C, the electrode holder 69 is formed (primary molding).

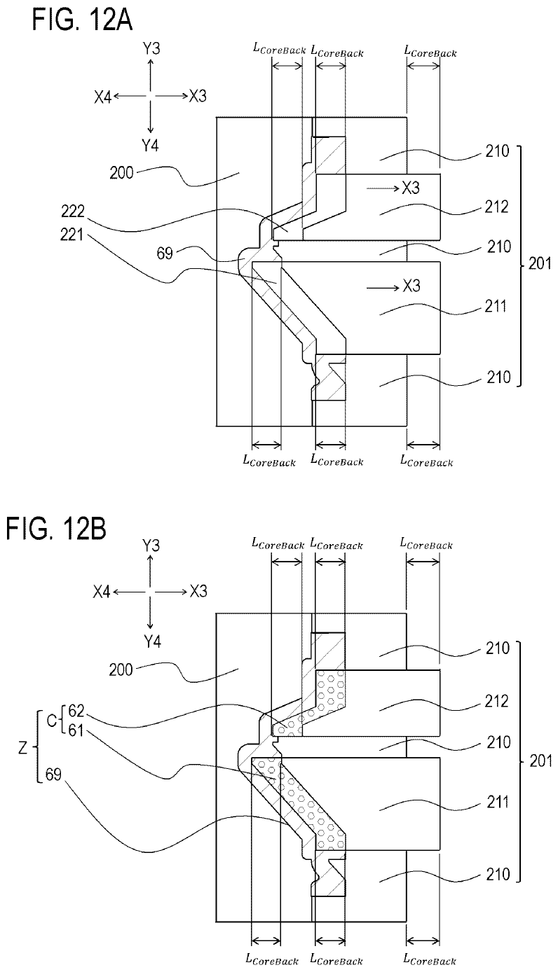

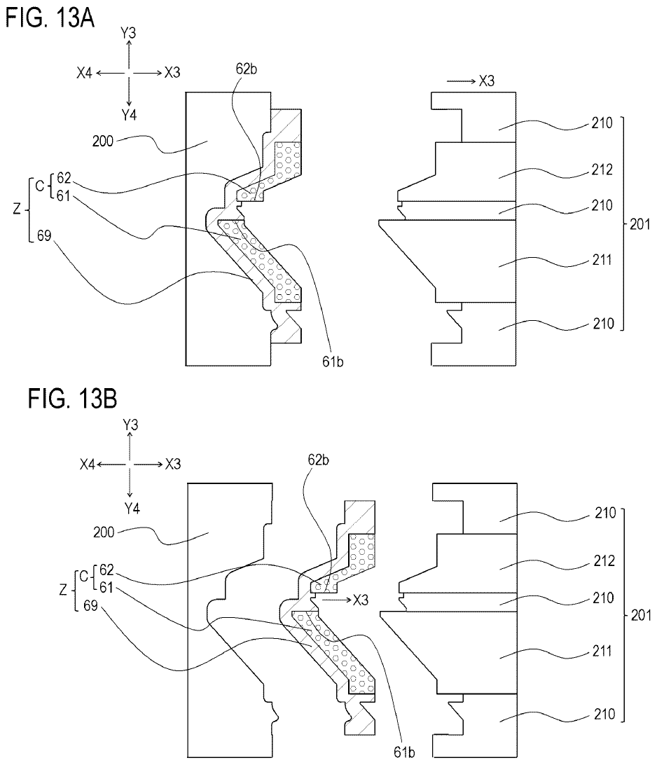

After forming the electrode holder 69, as shown in FIG. 12A, the detection capacitor mold first core back portion 211 and the detection capacitor mold second core back portion 212 are moved toward the detection capacitor closest perpendicular direction X3 by a core back amount L_{Coreback}. By core backing of the detection capacitor mold first core back portion 211, a detection capacitor mold first core back space 221 is formed in the mold. Similarly, by core backing of the detection capacitor mold second core back portion 212, a detection capacitor mold second core back space 222 is formed in the mold. In this state, when a conductive resin which is a second molding material is molded in the mold, as shown in FIG. 12B, the detection capacitor C composed of the first electrode 61 and the second electrode 62 is formed (secondary molding). A wall thickness of the detection capacitor C in the detection capacitor closest perpendicular direction X4 is substantially equal to a product of the core back amount L_{Coreback} and a molding shrinkage rate of the conductive resin. That is, each thickness of the first electrode 61 and the second electrode 62 in a normal direction of detection capacitor connection wall surfaces 52a and 52b is substantially equal. As shown in FIG. 13A, after forming the detection capacitor C, the detection capacitor mold core 201 is moved toward the detection capacitor closest perpendicular direction X3. Finally, as shown in FIG. 13B, the detection capacitor C moves toward the detection capacitor closest perpendicular direction X3 with respect to the detection capacitor mold cavity 200. As a result, the remaining amount detection member Z is released from the detection capacitor mold cavity 200 and the detection capacitor mold core 201, and conductive two-color molding is completed.

As shown in FIGS. 11A to 11C to 13A and 13B, the detection capacitor C is formed by core backing of the detection capacitor mold core 201. Therefore, a first electrode tip facing surface 61b (first facing surface) and a second electrode tip facing surface 62b (second facing surface) are formed parallel to each other with respect to the core back direction, which is the detection capacitor closest perpendicular direction X3 and X4. The above procedure completes conductive two-color molding of the remaining amount detection member Z composed of the detection capacitor C and the electrode holder 69.

### Configuration of Remaining Amount Detection Member Z

As shown in FIGS. 1 and 15, the developing unit 50 is provided with a developing frame body 52, a stirring member 63, and the remaining amount detection member Z. The stirring member 63 is composed of a stirring shaft 63a and a stirring sheet 63b, and is pivotally supported with respect to the developing frame body 52 so as to be rotatable around a rotation shaft center 63c of the stirring member 63 (around a rotation axis of the stirring shaft 63a) in a stirring sheet rotation direction R6. One end of the stirring sheet is fixed to the stirring shaft 63a, and the other end side flexes as a free end following an inner wall of the toner accommodating portion 60 while periodically circulating and stirring toner at time intervals of the stirring cycle T_{Age}.

The electrode holder 69 that forms the remaining amount detection member Z is integrally connected to two detection capacitor connection wall surfaces 52a and 52b provided in the developing frame body 52. On the other hand, the detection capacitor C shown in FIG. 15 is also integrally connected to a detection capacitor connection first side wall 52c and a detection capacitor connection second side wall 52d at both ends in the longitudinal direction Z1 and Z2. That is, the detection capacitor C is integrally connected to the developing frame body 52 along a closed curve connection surface formed by the detection capacitor connection wall surfaces 52a and 52b, the detection capacitor connection first side wall 52c, and the detection capacitor connection second side wall 52d. These connection surfaces (detection capacitor connection wall surfaces 52a and 52b, detection capacitor connection first side wall 52c, detection capacitor connection second side wall 52d) are surfaces continuous with an outer wall of the developing frame body 52 and are substantially parallel to the rotation axis of the stirring member 63.

Further, the first electrode 61 that forms the detection capacitor C is disposed with an inclination of a first electrode inclination angle θ61 set larger than an angle of repose of toner with respect to the horizontal direction X1 and X2. A closest direction of the first electrode 61 and the second electrode 62 (hereinafter referred to as detection capacitor closest direction Y3 and Y4) is provided substantially parallel to the detection capacitor connection wall surfaces 52a and 52b. In other words, a detection capacitor closest perpendicular direction X3 and X4 perpendicular to the detection capacitor closest direction Y3 and Y4 is provided substantially perpendicular to the detection capacitor connection wall surfaces 52a and 52b. A stirring center-detection capacitor connection inner wall distance L_{Bond}, which is a distance from the rotation shaft center 63c of the stirring member 63 to the inner wall side of the toner accommodating portion 60 of the detection capacitor connection wall surfaces 52a and 52b, is provided shorter than a stirring center-detection capacitor start end distance L_{Cap}, which is similarly a distance from the rotation shaft center 63c to the detection capacitor connection wall surfaces 52a and 52b. The stirring center-detection capacitor connection inner wall distance L_{Bond} is a distance from the rotation shaft center 63c to a region of an inner wall of the developing frame body 52 corresponding to the detection capacitor connection wall surfaces 52a and 52b continuous with an outer wall of the developing frame body 52.

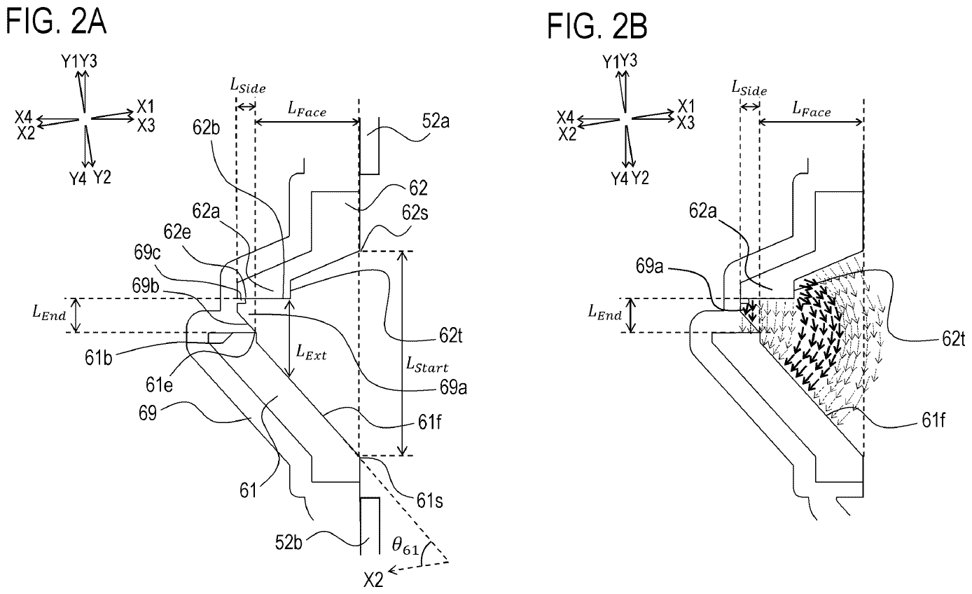

As shown in FIG. 2A, the first electrode 61 has a first electrode start end 61s (first end) far from the second electrode 62 and a first electrode terminal end 61e (second end) close to the second electrode 62 in a rotation direction centered on the rotation axis of the stirring member 63. The first electrode 61 has an upstream side end portion (first upstream side end portion) on an upstream side in the rotation direction of the stirring member 63 and a downstream side end portion (first downstream side end portion) on a downstream side when viewed in a direction of the rotation axis of the stirring member 63. When viewed in the direction of the rotation axis of the stirring member 63, the upstream side end portion of the first electrode 61 is an end portion close to the rotation axis in the first electrode 61, and the downstream side end portion of the first electrode 61 is an end portion far from the rotation axis in the first electrode 61. The first electrode start end 61s is a part of the upstream side end portion of the first electrode 61, and the first electrode terminal end 61e is a part of the downstream side end portion of the first electrode 61. Similarly, the second electrode 62 has a second electrode start end 62s (fourth end) far from the first electrode 61 and a second electrode terminal end 62e (third end) close to the first electrode 61 in the rotation direction centered on the rotation axis of the stirring member 63. The second electrode 62 has an upstream side end portion (second upstream side end portion) on the upstream side in the rotation direction of the stirring member 63 and a downstream side end portion (second downstream side end portion) on the downstream side when viewed in the direction of the rotation axis of the stirring member 63. When viewed in the direction of the rotation axis of the stirring member 63, the upstream side end portion of the second electrode 62 is an end portion far from the rotation axis in the second electrode 62, and the downstream side end portion of the second electrode 62 is an end portion close to the rotation axis in the second electrode 62. The second electrode start end 62s is a part of the downstream side end portion of the second electrode 62, and the second electrode terminal end 62e is a part of the upstream side end portion of the second electrode 62. The first electrode 61 and the second electrode 62 are disposed so as to face each other in the rotation direction of the stirring member 63, and when viewed in the direction of the rotation axis, are disposed such that a facing interval becomes narrower from an end portion close to the rotation axis toward an end portion far from the rotation axis. The first electrode start end 61s, which is one end of the first electrode 61 in the detection capacitor closest direction Y3 and Y4, is formed substantially flush with the detection capacitor connection wall surfaces 52a and 52b. The second electrode start end 62s, which is one end of the second electrode 62 in the detection capacitor closest direction Y3 and Y4, is also similarly formed substantially flush with the detection capacitor connection wall surfaces 52a and 52b. Therefore, when the free end of the stirring sheet 63b conveys toner toward the detection capacitor C following the inner wall of the toner accommodating portion 60, in the detection capacitor closest perpendicular direction X3 and X4 which is a penetration direction of the stirring sheet 63b with respect to the inner wall of the toner accommodating portion 60, the detection capacitor C, that is, the first electrode 61 and the second electrode 62, is provided on a side farther from the free end of the stirring sheet 63b than the detection capacitor connection wall surfaces 52a and 52b. The detection capacitor connection first side wall 52c and the detection capacitor connection second side wall 52d shown in FIG. 15 are formed on the same surface as the detection capacitor connection wall surfaces 52a and 52b shown in FIGS. 1, 2A, and 2B. Therefore, the relationship that the above-described stirring center-detection capacitor connection inner wall distance L_{Bond} is provided shorter than the stirring center-detection capacitor start end distance L_{Cap} is satisfied.

Further, as shown in FIGS. 1 and 2A, the first electrode 61 has a first electrode terminal end 61e which is the other end side in the detection capacitor closest direction Y3 and Y4. Further, the first electrode 61 has a first electrode exposed portion 61f formed between the first electrode start end 61s and the first electrode terminal end 61e. On the other hand, the second electrode 62 has a second electrode terminal end 62e which is the other end side in the detection capacitor closest direction Y3 and Y4 direction. Further, the second electrode 62 has an electrode protruding portion 62a which is a protrusion protruding toward the first electrode 61 in the detection capacitor closest direction Y4 between the second electrode start end 62s and the second electrode terminal end 62e. The electrode protruding portion 62a is formed of a second electrode tip facing surface 62b having a normal of the detection capacitor closest direction Y3 and Y4 and a second electrode shear surface 62t having a normal of the detection capacitor closest perpendicular direction X3 and X4. The second electrode tip facing surface 62b is an end surface of the second electrode terminal end 62e extending substantially parallel to the rotation axis of the stirring member 63 and in a normal direction of the detection capacitor connection wall surfaces 52a and 52b, and is a surface substantially parallel to the first electrode tip facing surface 61b which is an end surface of the first electrode terminal end 61e. The electrode protruding portion 62a is a corner portion of the second electrode 62 composed of the second electrode tip facing surface 62b and the second electrode shear surface 62t continuous therewith. Further, the first electrode tip facing surface 61b and the second electrode tip facing surface 62b have regions that overlap each other when viewed in a direction orthogonal to the rotation axis of the stirring member 63 and along the detection capacitor connection wall surfaces 52a and 52b. A shortest distance between the first electrode 61 and the second electrode 62 in the same direction is formed between the first electrode tip facing surface 61b and the second electrode tip facing surface 62b. That is, an electrode start end distance L_{Start} is a distance in the detection capacitor closest direction (Y3, Y4) between the first electrode start end 61s and the second electrode start end 62s in a direction orthogonal to the rotation axis of the stirring member 63 and along the detection capacitor connection wall surfaces 52a and 52b. Further, an electrode terminal end distance L_{End} is a distance in the detection capacitor closest direction Y3 and Y4 between the first electrode terminal end 61e and the second electrode terminal end 62e in the same direction. The electrode start end distance L_{Start} is provided longer than the electrode terminal end distance L_{End}. The first electrode terminal end 61e and the second electrode terminal end 62e are disposed on the detection capacitor closest perpendicular direction X4 side with respect to the first electrode start end 61s and the second electrode start end 62s, that is, on a side far from the rotation shaft center 63c of the stirring member 63. An electrode protruding portion distance L_{Ext}, which is a distance in the detection capacitor closest direction Y3 and Y4 between the electrode protruding portion 62a and the first electrode exposed portion 61f, is provided between the electrode terminal end distance L_{End} and the electrode start end distance L_{Start}. From the viewpoint of stabilizing the remaining amount detection signal V_{(SNS(t))} by securing the electrostatic capacitance of the detection capacitor C and maintaining mass productivity by securing the strength of the detection capacitor mold core base portion 210, the electrode terminal end distance L_{End} is provided between 1 mm and 2.5 mm.

The first electrode 61 and the second electrode 62 of the detection capacitor C face each other with their exposed portions in a detection capacitor facing region L_{Face} which is a component of the detection capacitor closest perpendicular direction X3 and X4 of the first electrode exposed portion 61f. On the other hand, in a detection capacitor non-facing region L_{Side} provided adjacent to the detection capacitor facing region L_{Face} in the detection capacitor closest perpendicular direction X4, a first non-facing shielding wall 69b and a second non-facing shielding wall 69c are provided. The first non-facing shielding wall 69b and the second non-facing shielding wall 69c shield a part of the first electrode tip facing surface 61b and the second electrode tip facing surface 62b within a region of the electrode terminal end distance L_{End} in the detection capacitor closest direction (Y3, Y4) of the electrode holder 69. Specifically, the first non-facing shielding wall 69b is a wall portion (first wall portion) of the electrode holder 69 that contacts the first electrode tip facing surface 61b and protrudes in a direction approaching the rotation axis of the stirring member 63 along the first electrode tip facing surface 61b. Similarly, the second non-facing shielding wall 69c is a wall portion (second wall portion) of the electrode holder 69 that contacts the second electrode tip facing surface 62b and protrudes in a direction approaching the rotation axis of the stirring member 63 along the second electrode tip facing surface 62b. The first non-facing shielding wall 69b is disposed with the first electrode inclination angle θ₆₁ similarly to the first electrode exposed portion 61f. In addition, an electrode recessed portion 69a, which is a space capable of accommodating toner, composed of the detection capacitor non-facing region L_{Side}, the electrode terminal end distance L_{End} region, the first non-facing shielding wall 69b, and the second non-facing shielding wall 69c is provided between the first electrode 61 and the second electrode 62. The electrode recessed portion 69a is recessed in a direction away from the rotation axis of the stirring member 63 between the first non-facing shielding wall 69b and the second non-facing shielding wall 69c. The first electrode 61 and the second electrode 62 are disposed in electrical non-contact by the electrode recessed portion 69a having a gap of the electrode terminal end distance L_{End}, thereby forming the detection capacitor C.

The first electrode exposed portion 61f, which is an exposed portion of the first electrode 61 in the toner accommodating portion (accommodating chamber) 60, is disposed with the first electrode inclination angle θ61 set larger than the angle of repose of toner. Therefore, after the stirring sheet 63b passes through the detection capacitor C in the detection capacitor closest direction Y3 direction, toner on the first electrode 61 falls down toward the vertical direction Y2 under the action of gravity. Therefore, in the toner entering and exiting movement to and from the detection capacitor C by rotation of the stirring member 63 shown in FIG. 1, it is possible to prevent retention of toner that has entered between the first electrode 61 and the second electrode 62. Further, the inter-electrode distances of the detection capacitor, the electrode protruding portion distance L_{Ext}, the electrode terminal end distance L_{End}, and the electrode start end distance L_{Start} are each formed by conductive two-color molding of the remaining amount detection member Z shown in FIGS. 11A to 11C to 13A and 13B. The inter-electrode distance, which is a characteristic factor of the electrostatic capacitance of the detection capacitor C, is determined by management of mold accuracy and molding conditions of two-color molding. Therefore, compared to a case where capacitor electrodes are provided by assembling or attaching a plurality of parts, variations due to fitting play during assembly and attachment position tolerances can be eliminated. By suppressing tolerances of the inter-electrode distance, the amplitude ΔV in the remaining amount detection signal V_{(SNS(t))} is further stabilized, so that highly accurate toner remaining amount detection becomes possible.

As shown in FIG. 2B, an electric field that forms electrostatic capacitance is formed between the first electrode 61 and the second electrode 62. Since the electrode protruding portion 62a is provided in the second electrode 62, an edge effect of electric lines of force generated from the second electrode shear surface 62t of the electrode protruding portion 62a is added. Due to the edge effect, the electrostatic capacitance of the detection capacitor C increases compared to a case without the electrode protruding portion 62a. Since the electrostatic capacitance increases, the amplitude ΔV in the remaining amount detection signal V_{(SNS(t))} increases, so that highly accurate toner remaining amount detection becomes possible.

Further, the detection capacitor C, that is, the first electrode 61 and the second electrode 62, are in a recess side arrangement on a side far from the free end of the stirring sheet 63b with respect to the same surface formed of the detection capacitor connection wall surfaces 52a and 52b, the detection capacitor connection first side wall 52c, and the detection capacitor connection second side wall 52d shown in FIGS. 1 and 15. Therefore, compared to a case where the first electrode 61 and the second electrode 62 are arranged in a protrusion side arrangement with respect to the detection capacitor connection wall surfaces 52a and 52b, spillage of toner when pumping up and conveying toner to the detection capacitor C by the stirring sheet 63b is suppressed. By suppressing spillage of toner, the pulsating waveform of the remaining amount detection signal V_{(SNS(t))} is further stabilized, so that highly accurate toner remaining amount detection becomes possible.

The first non-facing shielding wall 69b and the second non-facing shielding wall 69c are disposed facing each other via the electrode recessed portion 69a in the detection capacitor closest direction Y3 and Y4. Therefore, at the time of injecting conductive resin which is the second material of conductive two-color molding shown in FIG. 12B, resin leakage from a gap between the detection capacitor mold core base portion 210 and the electrode holder 69 of the conductive resin of the first electrode 61 and the second electrode 62 is prevented by a labyrinth action. By preventing resin leakage, electrical insulation between the first electrode 61 and the second electrode 62 can be stably performed, so that mass productivity of conductive two-color molding can be secured. Further, in the detection capacitor non-facing region L_{Side}, the first electrode 61 and the second electrode 62 are not disposed facing each other in an exposed state, but electric lines of force are generated by providing the electrode recessed portion 69a. In addition, since the electrode recessed portion 69a can form a minute gap equal to or less than the electrode terminal end distance L_{End}, the strongest electric field can be formed in the detection capacitor C. As a result, the electrostatic capacitance of the detection capacitor C increases compared to a case without the electrode recessed portion 69a, so that highly accurate toner remaining amount detection becomes possible by increasing the amplitude ΔV similarly to the electrode protruding portion 62a.

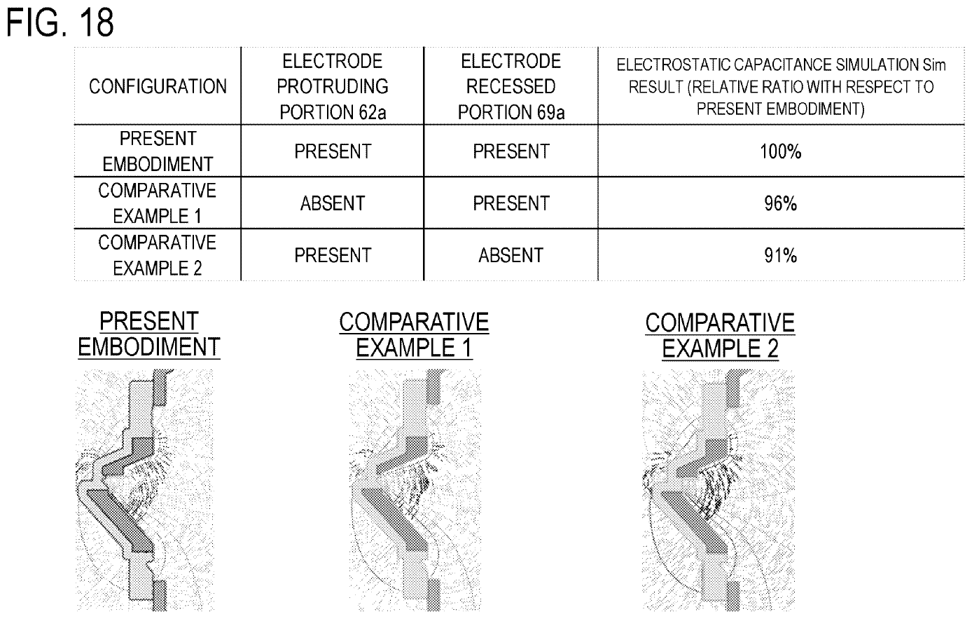

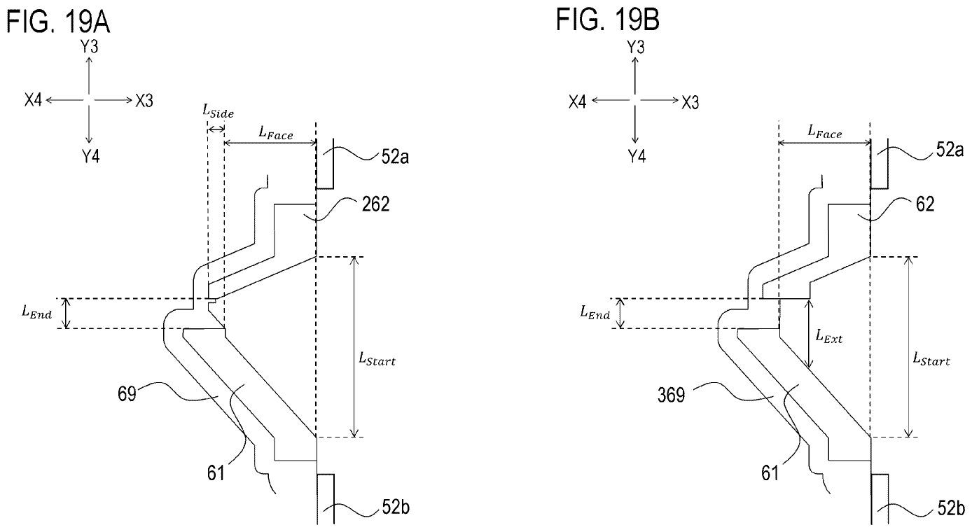

Effects of the present embodiment by electrostatic capacitance simulation will be described with reference to FIGS. 18 and 19A and 19B. FIGS. 19A and 19B are comparative examples of the detection capacitor C with respect to the present embodiment. FIG. 18 shows results of electrostatic capacitance simulation of the present embodiment and the comparative examples shown in FIGS. 19A and 19B. A second electrode 262 of comparative example 1 shown in FIG. 19A is a configuration in which the electrode protruding portion 62a is removed from the second electrode 62 of the present embodiment. On the other hand, an electrode holder 369 of comparative example 2 shown in FIG. 19B is a configuration in which the electrode recessed portion 69a is removed from the electrode holder 69 of the present embodiment. As shown in the electrostatic capacitance simulation results of FIG. 18, the present embodiment (with electrode protruding portion 62a) obtains an electrostatic capacitance improvement effect of about 4% with respect to comparative example 1 (without electrode protruding portion 62a), and also obtains an electrostatic capacitance improvement effect of about 9% with respect to comparative example 2 (without electrode recessed portion 69a).

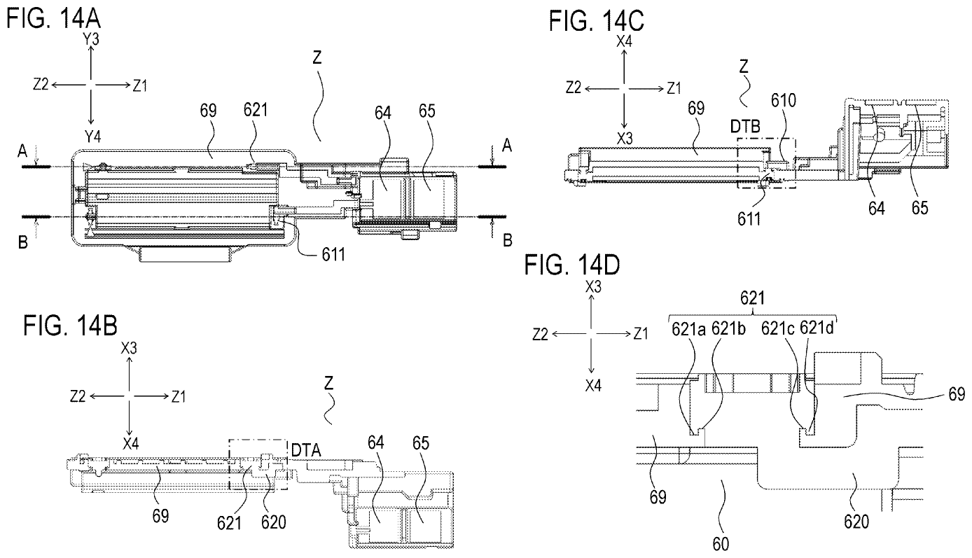

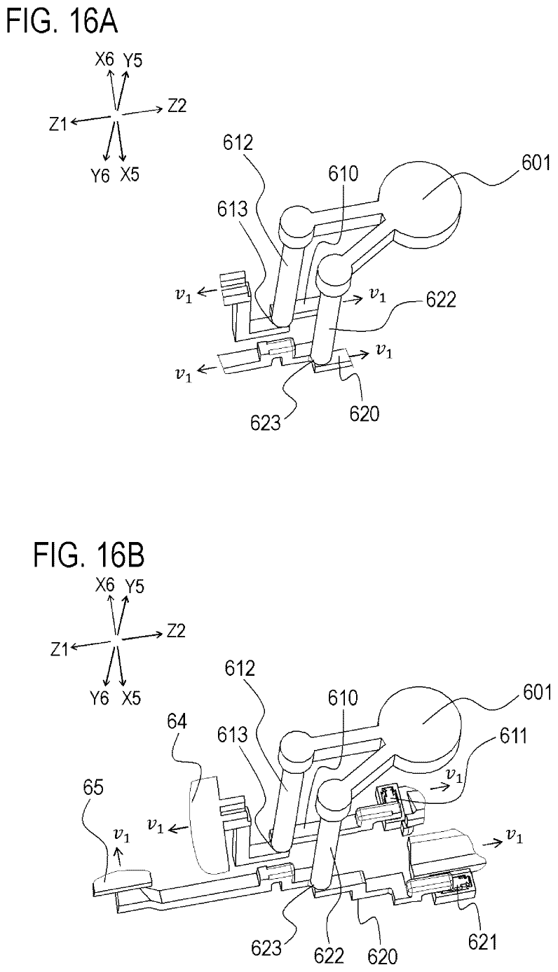

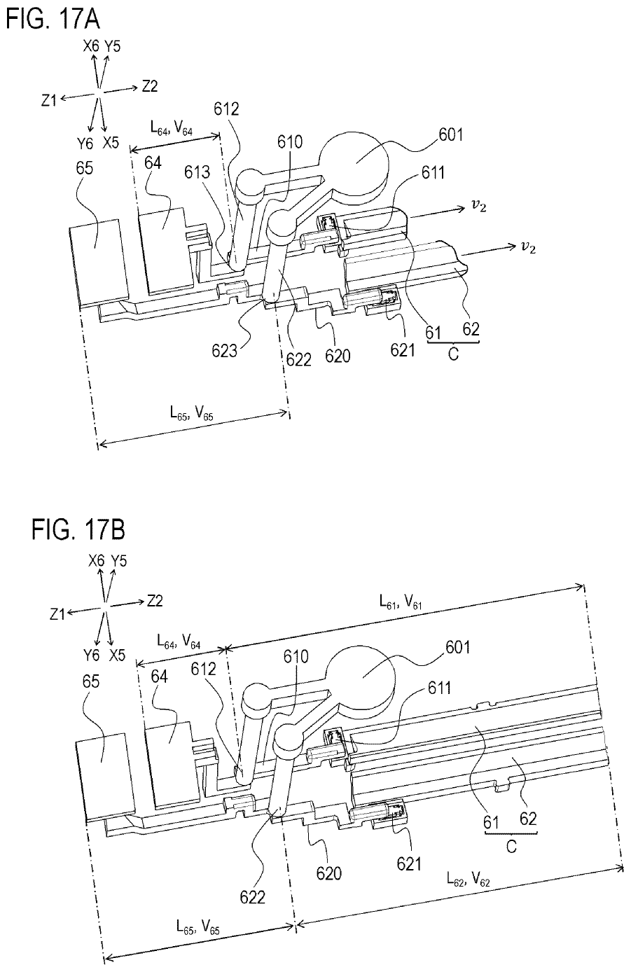

A conductive resin configuration of the remaining amount detection member Z will be described with reference to FIGS. 6A, 6B, 14A to 14D, 16A, 16B, 17A, and 17B. FIG. 14A is a front view showing a configuration of the remaining amount detection member Z. FIGS. 14B and 14C are longitudinal cross-sectional views showing a toner seal structure of FIG. 14A, respectively. FIG. 14D is a detailed view of the toner seal structure described in FIGS. 14B and 14C. FIGS. 16A, 16B, 17A, and 17B are explanatory diagrams of a resin flow passage and gate arrangement configuration in conductive resin molding of the detection capacitor C and the electrical contacts 64 and 65.

As shown in FIGS. 14A and 6A and 6B, the remaining amount detection member Z is an electrostatic capacitance type toner remaining amount detection signal detection member composed of the electrode holder 69, the detection capacitor C, and the electrical contacts 64 and 65, and is manufactured by conductive two-color molding shown in FIGS. 11A to 11C to 13A and 13B. As shown in FIG. 14C, the first electrical contact 64 and the first electrode 61 are integrally molded via a first electrode flow passage 610 and a first electrode toner sealing portion 611 in the conductive resin molding process shown in FIG. 12B, so both are electrically connected. As shown in FIG. 14B, the second electrical contact 65 and the second electrode 62 are also integrally molded via a second electrode flow passage 620 and a second electrode toner sealing portion 621 in the conductive resin molding process shown in FIG. 12B, so both are electrically connected. Further, the conductive resin in the present embodiment is formed of conductive POM which is polyacetal (POM) containing about 10% carbon black (hereinafter referred to as CB). The insulating resin of the electrode holder 69 is PS+PPE resin, but is not limited thereto.

As shown in FIG. 14D, the second electrode flow passage 620 and the second electrode toner sealing portion 621 are integrally molded with conductive resin and are integrally coupled to the electrode holder 69. Since the first electrode flow passage 610 and the first electrode toner sealing portion 611 also have the same configuration, a toner seal structure by the second electrode toner sealing portion 621 and the second electrode flow passage 620 will be described here.

The second electrode toner sealing portion 621 is composed of second electrode toner sealing protruding portions 621a and 621d and second electrode toner sealing recessed portions 621b and 621c. The second electrode toner sealing protruding portions 621a and 621d are disposed on a longitudinal direction Z1 and Z2 outer side with respect to the second electrode toner sealing recessed portions 621b and 621c and in the detection capacitor closest perpendicular direction X4 which is a side toward the toner accommodating portion 60. In other words, the second electrode toner sealing recessed portions 621b and 621c are disposed on a longitudinal direction Z1 and Z2 inner side with respect to the second electrode toner sealing protruding portions 621a and 621d and in the detection capacitor closest perpendicular direction X3 which is a side away from the toner accommodating portion 60.

The electrical contacts 64 and 65 and the detection capacitor C are molded in the flow shown in FIGS. 16A, 16B, 17A, and 17B. First, as shown in FIG. 16A, conductive resin injected into a runner 601 at a predetermined injection speed from an injection molding machine (not shown) branches into a first electrode gate portion 612 and a second electrode gate portion 622. During molding, the conductive resin flowing through the first electrode gate portion 612 starts to flow into the first electrode flow passage 610 via a first gate connection portion 613. Similarly, the conductive resin flowing through the second electrode gate portion 622 starts to flow into the second electrode flow passage 620 via a second gate connection portion 623. The first gate connection portion 613 is a conductive resin introduction port (first injected portion) provided in the middle of the first electrode flow passage 610 as a conductive path connecting the first electrode 61 and the first electrical contact 64. The second gate connection portion 623 is a conductive resin introduction port (second injected portion) provided in the middle of the second electrode flow passage 620 as an conductive path connecting the second electrode 62 and the second electrical contact 65. Next, as shown in FIG. 16B, the first electrode flow passage 610 and the second electrode flow passage 620 each branch toward a longitudinal direction Z1 which is a side toward the electrical contacts 64 and 65 and a longitudinal direction Z2 which is a side toward the detection capacitor C. Further, as shown in FIG. 17A, the conductive resin on the longitudinal direction Z2 side flows beyond the first electrode toner sealing portion 611 and the second electrode toner sealing portion 621 to a part of the detection capacitor C. At this stage, the conductive resin on the longitudinal direction Z1 side is filled by a first electrical contact molding distance L64 and a second electrical contact molding distance L65, respectively, and filling of the electrical contacts 64 and 65 is completed. At this time, resin filling volumes from each gate (each gate connection portion 613, 623) to the electrical contacts 64 and 65 are defined as a first electrical contact molding volume V₆₄ and a second electrical contact molding volume V₆₅, respectively. Further, as shown in FIG. 17A, the conductive resin injected into the runner 601 at a predetermined injection speed from the injection molding machine (not shown) does not branch toward the longitudinal direction Z1 which is a side toward the electrical contacts 64 and 65 in the first electrode flow passage 610 and the second electrode flow passage 620, but is filled only toward the longitudinal direction Z2 which is a side toward the detection capacitor C. Therefore, from the law of flow rate, as shown in FIGS. 16A and 16B, a pre-electrical contact formation flow velocity v₁ until molding the electrical contacts 64 and 65, as shown in FIG. 17A, a post-electrical contact formation flow velocity v₂ which is a flow velocity from after molding the electrical contacts 64 and 65 until molding of the detection capacitor C is completed is higher than the pre-electrical contact formation flow velocity v₁. Finally, as shown in FIG. 17B, when molding of the detection capacitor C is completed, the conductive resin on the longitudinal direction Z2 side is filled by a first electrode molding distance L61 and a second electrode molding distance L62, respectively. At this time, resin filling volumes from each gate to the detection capacitor C are defined as a first electrode molding volume V₆₁ and a second electrode molding volume V₆₂, respectively. In order to satisfy the relationship of pre-electrical contact formation flow velocity v₁<post-electrical contact formation flow velocity v₂, the first electrode gate portion 612 and the second electrode gate portion 622 are each arranged so as to satisfy the following equations.

First Electrical Contact Molding Volume V₆₄<First Electrode Molding Volume V₆₁
Second Electrical Contact Molding Volume V₆₅<Second Electrode Molding Volume V₆₂

In the remaining amount detection member Z of the present embodiment, in conductive two-color molding, the second electrode toner sealing protruding portions 621a and 621d tighten inward in the longitudinal direction Z1 and Z2 of the second electrode toner sealing recessed portions 621b and 621c by molding shrinkage to seal toner inside the toner accommodating portion 60. Here, when the material of the developing frame body 52 shown in FIG. 1 is PS-based resin, compatibility with the electrode holder 69 can be obtained. Therefore, it becomes possible to join by methods such as ultrasonic welding and heat caulking without using other materials such as adhesives and tapes, which provides advantages in securing strength, cost reduction, and reducing environmental load. Further, the first electrical contact 64, the first electrode 61, the first electrode flow passage 610, and the first electrode toner sealing portion 611 are all integrated by conductive two-color molding, so contact resistance between these elements does not exist and only internal resistance exists. Similarly, contact resistance between the elements of the second electrical contact 65, the second electrode 62, the second electrode flow passage 620, and the second electrode toner sealing portion 621 does not exist and only internal resistance exists. Therefore, compared to a configuration in which the electrical contacts 64 and 65 and the detection capacitor C are provided as separate parts and both are electrically connected, contact resistance between parts is eliminated, so parasitic resistance R which is an attenuation factor of the remaining amount detection signal V_{(SNS(t))} can be suppressed.

Further, in the remaining amount detection member Z of the present embodiment, since the relationship of pre-electrical contact formation flow velocity v₁<post-electrical contact formation flow velocity v₂ is satisfied, the injection speed of conductive resin in the electrical contacts 64 and 65 can be kept low. By keeping the injection speed of conductive resin low, shear fracture of CB contained in the conductive resin is suppressed on surfaces of the electrical contacts 64 and 65 formed by a skin layer with the mold, so conductive action by CB is maintained even after molding. As a result, an increase in surface resistance of the electrical contacts 64 and 65 is prevented, so contact resistance with the electrical contact springs 90 and 91 shown in FIGS. 8A, 8B, and 9A to 9C is suppressed, so parasitic resistance R which is an attenuation factor of the remaining amount detection signal V_{(SNS(t))} can be suppressed. On the other hand, the surface resistance in the detection capacitor C filled at the post-electrical contact formation flow velocity v₂ becomes higher than the surface resistance of the electrical contacts 64 and 65 due to shear fracture of CB from the relationship of pre-electrical contact formation flow velocity v₁<post-electrical contact formation flow velocity v₂. However, the detection capacitor C is merely configured to detect a change in electrostatic capacitance due to toner entering and exiting inside the toner accommodating portion 60 as capacitive reactance, so an increase in surface resistance in the detection capacitor C does not become an attenuation factor of the remaining amount detection signal V_{(SNS(t))}. Therefore, in an integrated configuration of the electrical contacts 64 and 65 and the detection capacitor C using conductive resin, in order to reduce surface contact resistance which is a member of parasitic resistance R as much as possible, it is configured such that the injection speed of conductive resin in the electrical contacts 64 and 65 is kept lower than other filling locations.

According to the present disclosure, an improved cartridge or an improved electrophotographic image forming apparatus can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-035939, filed on Mar. 6, 2025, which is hereby incorporated by reference herein in its entirety.

What is claimed is:

1. A developing device comprising:
a developing roller;
a frame body having an accommodating portion for accommodating developer to be borne on the developing roller, the frame body is formed of an insulating resin; and
a first conductive portion and a second conductive portion integrally molded by injecting a conductive resin into the frame body,
wherein the first conductive portion includes a first electrode portion and a first electrical contact portion, the first electrode portion being exposed in the accommodating portion, the first electrical contact portion being electrically connected to the first electrode portion and being exposed outside the accommodating portion,
wherein the second conductive portion includes a second electrode portion and a second electrical contact portion, the second electrode portion being exposed from the frame body inside the accommodating portion, the second electrical contact portion being electrically connected to the second electrode portion and being exposed from the frame body outside the accommodating portion,
wherein the first electrode portion and the second electrode portion are disposed so as to face each other with a space therebetween and are configured to function as a capacitor when a voltage is applied between the first electrical contact portion and the second electrical contact portion.

2. The developing device according to claim 1,
wherein the first conductive portion has a first connection portion connecting the first electrode portion and the first electrical contact portion, the first connection portion being provided with a first injected portion into which the conductive resin is injected during molding,
wherein the second conductive portion has a second connection portion connecting the second electrode portion and the second electrical contact portion, the second connection portion is provided with a second injected portion into which the conductive resin was injected during molding,
wherein a volume of the first conductive portion between the first injected portion and the first electrical contact portion is smaller than a volume of the first conductive portion between the first injected portion and the first electrode portion, and
wherein a volume of the second conductive portion between the second injected portion and the second electrical contact portion is smaller than a volume of the second conductive portion between the second injected portion and the second electrode portion.

3. The developing device according to claim 2, further comprising a stirring member that stirs developer accommodated in the accommodating portion by rotating around a rotation axis inside the accommodating portion,
wherein the first electrode portion and the second electrode portion are disposed so as to face each other in a rotation direction of the stirring member centered on the rotation axis, and
wherein the first electrode portion and the second electrode portion are disposed such that a facing interval thereof becomes narrower from an end portion close to the rotation axis toward an end portion far from the rotation axis when viewed in a direction of the rotation axis.

4. The developing device according to claim 3,
wherein the frame body includes a first frame body portion that rotatably supports the stirring member and a second frame body portion separate from the first frame body portion, the second frame body portion being integrally molded with the first conductive portion and the second conductive portion,
wherein the first frame body portion has a connection surface that is parallel to the rotation axis and connected to the second frame body portion,
wherein in a cross section orthogonal to the rotation axis, the second electrode portion is on a downstream side with respect to the first electrode portion in the rotation direction,
wherein in the cross section orthogonal to the rotation axis, the first electrode portion has a first upstream side end portion on an upstream side in the rotation direction and a first downstream side end portion on a downstream side in the rotation direction,
wherein in the cross section orthogonal to the rotation axis, the second electrode portion has a second downstream side end portion on the downstream side in the rotation direction and a second upstream side end portion on an upstream side in the rotation direction,
wherein in the cross section orthogonal to the rotation axis, the first upstream side end portion is an end portion close to the rotation axis in the first electrode portion in a case of viewing in the direction of the rotation axis,
wherein in the cross section orthogonal to the rotation axis, the first downstream side end portion is an end portion far from the rotation axis in the first electrode portion in a case of viewing in the direction of the rotation axis,
wherein in the cross section orthogonal to the rotation axis, the second upstream side end portion is an end portion far from the rotation axis in the second electrode portion in a case of viewing in the direction of the rotation axis,
wherein in the cross section orthogonal to the rotation axis, the second downstream side end portion is an end portion close to the rotation axis in the second electrode portion in a case of viewing in the direction of the rotation axis,
wherein in a normal direction normal to the connection surface, a distance from the rotation axis to an end surface of the first upstream side end portion is longer than a distance from the rotation axis to the connection surface,
wherein in the normal direction of the connection surface, a distance from the rotation axis to an end surface of the first downstream side end portion is longer than the distance from the rotation axis to the end surface of the first upstream side end portion,
wherein in the normal direction of the connection surface, a distance from the rotation axis to an end surface of the second downstream side end portion is longer than the distance from the rotation axis to the connection surface, and
wherein in the normal direction of the connection surface, a distance from the rotation axis to an end surface of the second upstream side end portion is longer than the distance from the rotation axis to the end surface of the second downstream side end portion.

5. The developing device according to claim 4,
wherein in the cross section orthogonal to the rotation axis, the first upstream end portion has a first end surface that is closest to the rotation axis in the normal direction and extends in a direction along the connection surface, and the first end surface has a first end closest to the second downstream side end portion in the direction along the connection surface,
wherein in the cross section orthogonal to the rotation axis, the first downstream end portion has a second end surface extending toward the rotation axis in the normal direction, and the second end surface has a second end closest to the rotation axis in the normal direction,
wherein in the cross section orthogonal to the rotation axis, the second upstream side end portion has a third end surface extending toward the rotation axis in the normal direction, and the third end surface has a region that is not shielded by the second frame body portion when viewed in a direction orthogonal to the normal direction, and the region has a third end farthest from the rotation axis in the normal direction,
wherein in the cross section orthogonal to the rotation axis, the second downstream side end portion has a fourth end surface that is closest to the rotation axis in the normal direction and extends in the direction along the connection surface, and the fourth end surface has a fourth end closest to the first upstream side end portion in the direction along the connection surface,
wherein in a direction orthogonal to the rotation axis and along the connection surface, a distance from the first end of the first upstream side end portion to the fourth end of the second downstream side end portion is longer than a distance from the second end of the first downstream side end portion to the third end of the second upstream side end portion.

6. The developing device according to claim 5,
wherein the second electrode portion has a protruding portion protruding toward the first electrode portion between the second downstream side end portion and the second upstream side end portion.

7. The developing device according to claim 6,
wherein the first electrode portion has a first facing surface at the first downstream side end portion, the first facing surface being parallel to the rotation axis and extending in the normal direction,
wherein the second electrode portion has a second facing surface parallel to the first facing surface at the second upstream side end portion,
wherein a shortest distance between the first electrode portion and the second electrode portion in a direction orthogonal to the rotation axis and along the connection surface is defined between the first facing surface and the second facing surface, and
wherein the protruding portion is formed of the second facing surface and a surface continuous with the second facing surface and extending in a direction orthogonal to the rotation axis and along the connection surface.

8. The developing device according to claim 7, wherein
in the direction orthogonal to the rotation axis and along the connection surface, the distance from the first end of the first upstream side end portion to the fourth end of the second downstream side end portion is longer than a distance from the first facing surface of the first electrode portion to the second facing surface of the protruding portion.

9. The developing device according to claim 8, wherein
when viewed in the direction orthogonal to the rotation axis and along the connection surface, the first facing surface and the second facing surface have regions that overlap each other.

10. The developing device according to claim 9, wherein
the second frame body portion comprises:
a first wall portion contacting the first facing surface and protruding in a direction of approaching the rotation axis along the first facing surface;
a second wall portion contacting the second facing surface and protruding in a direction of approaching the rotation axis along the second facing surface; and
a recessed portion recessed in a direction away from the rotation axis between the first wall portion and the second wall portion.

11. The developing device according to claim 4, wherein
thickness of the first electrode portion and thickness of the second electrode portion in the normal direction are equal.

12. The developing device according to claim 11, wherein
in the normal direction, the second upstream side end portion is at a position closer to the rotation axis than the first downstream side end portion.

13. The developing device according to claim 11, wherein
in the normal direction, the first upstream side end portion and the second downstream side end portion are at the same position.

14. The developing device according to claim 3, wherein
the stirring member has a rotation shaft that rotates around the rotation axis and a stirring sheet having one end fixed to the rotation shaft.
